(19) United States
(12) Patent Application Publication
(10) Pub. No.: US 2026/0238768 A1
(43) Pub. Date: Aug. 13, 2026

(54) ENCODING METHOD, DECODING METHOD, ENCODER, DECODER, AND STORAGE MEDIUM

(71) Applicant: GUANGDONG OPPO MOBILE TELECOMMUNICATIONS CORP., LTD., Dongguan (CN)

(72) Inventor: Zexing SUN, Dongguan (CN)

(73) Assignee: GUANGDONG OPPO MOBILE TELECOMMUNICATIONS CORP., LTD., Dongguan (CN)

(21) Appl. No.: 19/640,267

(22) Filed: Apr. 6, 2026

Related U.S. Application Data
(63) Continuation of application No. PCT/CN2023/123614, filed on Oct. 9, 2023.

(51) Int. Cl. H04N 19/107; H04N 19/169; H04N 19/597; H04N 19/61; H04N 19/70

(52) U.S. Cl. CPC H04N 19/107; H04N 19/1883; H04N 19/597; H04N 19/61; H04N 19/70

(57) ABSTRACT

Provided in the embodiments of the present application are an encoding method, a decoding method, an encoder, a decoder, and a storage medium. The decoding method comprises: parsing a code stream, and determining first information, wherein the first information is used for indicating a target decoding mode from a plurality of decoding modes corresponding to a current layer, and the plurality of decoding modes comprise RAHT transform decoding and RAHT prediction-combined-transform decoding; and decoding attribute information of a node of the current layer on the basis of the target decoding mode.

### CROSS-REFERENCE TO RELATED APPLICATIONS

This application is a continuation of International Application No. PCT/CN2023/123614, filed on Oct. 9, 2023, the disclosure of which is hereby incorporated by reference in its entirety.

### TECHNICAL FIELD

This application relates to the field of point cloud encoding and decoding technologies, and in particular, to an encoding method, a decoding method, an encoder, a decoder, and a storage medium.

### BACKGROUND

In a process of encoding point cloud attribute information, if region adaptive hierarchical transform (RAHT) inter prediction is enabled, an optimal RAHT prediction mode is selected from RAHT inter prediction and RAHT intra prediction in the related technology.

However, in some cases, prediction performance of both the RAHT inter prediction and the RAHT intra prediction is relatively poor. In this case, if a solution provided by the related technology is adopted, encoding performance of the point cloud attribute information is poor.

### SUMMARY

Embodiments of this application provide an encoding method, a decoding method, an encoder, a decoder, and a storage medium, to improve encoding performance of attribute information of a point cloud. Various aspects of this application are described below.

According to a first aspect, there is provided a decoding method. The decoding method is applied to a decoder, and includes: parsing a bitstream to determine first information, where the first information is used to indicate a target decoding mode from a plurality of decoding modes corresponding to a current layer, and the plurality of decoding modes include RAHT decoding and RAHT prediction combined with transform decoding; and decoding attribute information of a node at the current layer according to the target decoding mode.

According to a second aspect, there is provided an encoding method. The encoding method is applied to an encoder, and includes: determining a target encoding mode corresponding to a current layer from a plurality of encoding modes, where the plurality of encoding modes include RAHT encoding and RAHT prediction combined with transform encoding; and encoding attribute information of a node at the current layer according to the target encoding mode.

According to a third aspect, there is provided a decoder. The decoder includes: a first decoding unit, configured to parse a bitstream to determine first information, where the first information is used to indicate a target decoding mode from a plurality of decoding modes corresponding to a current layer, and the plurality of decoding modes include RAHT decoding and RAHT prediction combined with transform decoding; and a second decoding unit, configured to decode attribute information of a node at the current layer according to the target decoding mode.

According to a fourth aspect, a decoder is provided, where the decoder includes: a memory, configured to store a computer program; and a processor, configured to execute the method according to the first aspect when running the computer program.

According to a fifth aspect, there is provided an encoder. The encoder includes: a first determining unit, configured to determine a target encoding mode corresponding to a current layer from a plurality of encoding modes, where the plurality of encoding modes include RAHT encoding and RAHT prediction combined with transform encoding; and a first encoding unit, configured to encode attribute information of a node at the current layer according to the target encoding mode.

According to a sixth aspect, an encoder is provided, where the encoder includes a memory, configured to store a computer program; and a processor, configured to execute the method according to the second aspect when running the computer program.

According to a seventh aspect, there is provided a computer-readable storage medium, where the computer-readable storage medium stores a computer program, and when the computer program is executed, the method according to the first aspect or the second aspect is implemented.

According to an eighth aspect, a non-volatile computer-readable storage medium storing a bitstream is provided, where the bitstream is generated by using an encoding method of an encoder, or the bitstream is decoded by using a decoding method of a decoder. The decoding method is the method according to the first aspect, and the encoding method is the method according to the second aspect.

### BRIEF DESCRIPTION OF DRAWINGS

FIG. 1A is a schematic diagram of a three-dimensional point cloud image.

FIG. 1B is a diagram of a locally enlarged view of a three-dimensional point cloud image.

FIG. 2A is a schematic diagram of a point cloud image viewed from six angles.

FIG. 2B is a schematic diagram of a data storage format corresponding to a point cloud image.

FIG. 3 is a schematic diagram of a network architecture of point cloud encoding and decoding.

FIG. 4A is a schematic diagram of a framework of a G-PCC encoder.

FIG. 4B is a schematic diagram of a framework of a G-PCC decoder.

FIG. 5A is a schematic diagram of low planar positions in a Z-axis direction.

FIG. 5B is a schematic diagram of high planar positions in a Z-axis direction.

FIG. 6 is a schematic diagram of a node encoding sequence.

FIG. 7A is a schematic diagram of a piece of planar mode information.

FIG. 7B is a schematic diagram of another piece of planar mode information.

FIG. 8 is a schematic diagram of sibling nodes of a current node.

FIG. 9 is a schematic diagram of intersection between lasers of a LiDAR device and a node.

FIG. 10 is a schematic diagram of a neighboring node at a same division depth and a same coordinate.

FIG. 11 is a schematic diagram showing that a current node is located on a low plane of a parent node.

FIG. 12 is a schematic diagram showing that a current node is located on a high plane of a parent node.

FIG. 13 is a schematic diagram of predictive encoding of planar position information of a LiDAR point cloud.

FIG. 14 is a schematic diagram of IDCM encoding.

FIG. 15 is a schematic diagram of coordinate transform of a point cloud acquired by a rotating LiDAR device.

FIG. 16 is a schematic diagram of predictive encoding in an X-axis or Y-axis direction.

FIG. 17A is a schematic diagram of an angle for predicting an X plane by using a horizontal azimuth.

FIG. 17B is a schematic diagram of an angle for predicting a Y plane by using a horizontal azimuth.

FIG. 18 is another schematic diagram of predictive encoding in an X-axis or Y-axis direction.

FIG. 19A is a schematic diagram of three vertices included in a block.

FIG. 19B is a schematic diagram of a triangle soup fitted by using three vertices.

FIG. 19C is a schematic diagram of up-sampling performed on a triangle soup.

FIG. 20 is an example diagram of a RAHT process.

FIG. 21 is another example diagram of a RAHT process.

FIG. 22 is a schematic diagram of RAHT and inverse RAHT.

FIG. 23 is a schematic structural diagram of an encoding block of attribute information.

FIG. 24 is a schematic diagram of an overall flow of RAHT intra prediction combined with transform encoding for attribute information.

FIG. 25 is an example diagram of a linear fitting method for neighboring attribute information of a current block.

FIG. 26 is a schematic flowchart of a decoding method according to an embodiment of this application.

FIG. 27 is a schematic structural diagram of a RAHT layer.

FIG. 28 is a schematic flowchart of an encoding method according to an embodiment of this application.

FIG. 29 is a schematic structural diagram of a decoder according to an embodiment of this application.

FIG. 30 is a schematic structural diagram of a decoder according to another embodiment of this application.

FIG. 31 is a schematic structural diagram of an encoder according to an embodiment of this application.

FIG. 32 is a schematic structural diagram of an encoder according to another embodiment of this application.

### DESCRIPTION OF EMBODIMENTS

To understand features and technical content of embodiments of this application in more detail, the following describes implementation of embodiments of this application in detail with reference to the accompanying drawings. The accompanying drawings are merely used for description, and are not intended to limit embodiments of this application.

Unless otherwise defined, all technical and scientific terms used in this specification have the same meaning as commonly understood by those skilled in the technical field of this application. The terms used herein are merely for the purpose of describing embodiments of this application, but are not intended to limit this application.

In the following descriptions, the term “some embodiments” describes a subset of all possible embodiments, but it may be understood that “some embodiments” may be the same subset or different subsets of all possible embodiments and may be combined without a conflict.

It should also be noted that the term “first/second/third” used in embodiments of this application is merely used to distinguish between similar objects and does not represent a specific order of objects. It may be understood that “first/second/third” may be interchanged if allowed, so that embodiments of this application described herein may be implemented in a sequence other than the sequence illustrated or described herein.

A point cloud is a three-dimensional representation of a surface of an object. By using a collection device such as an optoelectronic radar, a LiDAR device, a laser scanner, or a multi-angle camera, a point cloud (data) of a surface of an object may be collected.

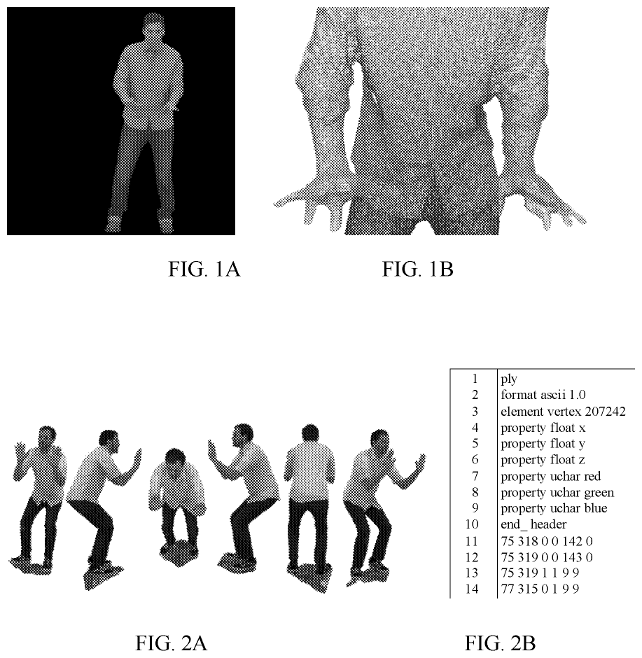

The point cloud is a set of discrete points in space that are irregularly distributed and represent a spatial structure and surface attributes of a three-dimensional object or scene. FIG. 1A is a three-dimensional point cloud image, and FIG. 1B is a locally enlarged view of the three-dimensional point cloud image. It can be seen that a surface of the point cloud includes densely distributed points.

Samples of a two-dimensional image each express some information and follow a distribution rule. Therefore, position information of the two-dimensional image does not need to be additionally recorded. However, points in a point cloud in a three-dimensional space are randomly and irregularly distributed. Therefore, a position of each point in the space needs to be recorded, to fully express the point cloud. Similar to that in the two-dimensional image, in a collection process, each position has corresponding attribute information, which is usually an RGB color value. The color value reflects a color of an object. For the point cloud, in addition to color information, attribute information corresponding to a respective point generally includes a reflectance value. The reflectance value reflects a surface material of the object. Therefore, data of the point cloud generally includes position information and attribute information of a point. The position information of the point may also be referred to as geometric information of the point. For example, the geometric information of the point may be three-dimensional coordinate information (x, y, z) of the point. The attribute information of the point may include color information and/or reflectance, and the like. For example, the reflectance may be one-dimensional reflectance information (r). The color information may be any type of information in color space, or the color information may be three-dimensional color information, for example, RGB information. Herein, R represents red (R), G represents green (G), and B represents blue (B). For another example, the color information may be luma and chroma (YCbCr, YUV) information, where Y represents luma, Cb(U) represents a blue color difference, and Cr(V) represents a red color difference.

A point in a point cloud obtained according to a laser measurement principle may have three-dimensional coordinate information of the point and a reflectance value of the point. For another example, a point in a point cloud obtained according to a photographing measurement principle may have three-dimensional coordinate information of the point and three-dimensional color information of the point. For another example, a point in a point cloud obtained according to a laser measurement principle and a photographing measurement principle may have three-dimensional coordinate information of the point, a reflectance value of the point, and three-dimensional color information of the point.

FIG. 2A and FIG. 2B show a point cloud image and a data storage format corresponding to the point cloud image. FIG. 2A provides six angles of viewing a point cloud image, and FIG. 2B includes a file header information part and a data part. Header information includes a data format, a data representation type, a total quantity of points in a point cloud, and content represented by the point cloud. For example, the point cloud is in a “.ply” format and is represented by an ASCII code. The total quantity of the points in the point cloud is 207242, and each point has three-dimensional coordinate information (x, y, z) and three-dimensional color information (r, g, b).

According to acquisition methods, point clouds may be classified into the following three types:
static point cloud, for which an object is static, and a device for acquiring the point cloud is also static;
dynamic point cloud, for which an object is moving, but a device for acquiring the point cloud is static; and
dynamically acquired point cloud, for which a device for acquiring the point cloud is moving.

For example, according to usage, point clouds are classified into the following two types:
type 1: machine perception point cloud, which may be used in scenarios such as an autonomous navigation system, a real-time inspection system, a geographic information system, a visual sorting robot, and a disaster relief robot; and
type 2: human eye point cloud, which may be used in point cloud application scenarios such as a digital cultural heritage, free viewpoint broadcasting, three-dimensional immersive communication, and three-dimensional immersive interaction.

A point cloud may flexibly and conveniently express a spatial structure and a surface attribute of a three-dimensional object or scene. Since the point cloud is obtained by directly performing sampling on a real object, an extremely strong sense of reality can be provided on a premise of ensuring precision. Therefore, the point cloud is widely applied in virtual reality gaming, computer-aided design, a geographic information system, an automatic navigation system, a digital cultural legacy, free viewpoint broadcasting, three-dimensional immersive remote presentation, three-dimensional reconstruction of a biological organ, and the like.

Point clouds are mainly collected in the following manners: computer generation, 3D laser scanning, 3D photographing measurement, and the like. A computer may be used to generate a point cloud of a virtual three-dimensional object or scene. 3D laser scanning may be used to obtain a point cloud of a three-dimensional object or scene in a static real world, and can acquire millions of point clouds per second. 3D photographing measurement may be used to obtain a point cloud of a three-dimensional object or scene in a dynamic real world, and can acquire tens of millions of point clouds per second. These technologies reduce costs and a time period of acquiring point cloud data, and improve data precision. The development in the manners of acquiring point cloud data makes it possible to acquire a large amount of point cloud data. With increasing application requirements, processing of massive 3D point cloud data encounters bottlenecks of limited storage space and transmission bandwidth.

Exemplarily, a point cloud video with a frame rate of 30 frames per second (fps) is used as an example. A quantity of points in each frame of point cloud is 700,000, and each point has coordinate information xyz (float) and color information RGB (uchar). In this case, a data volume of a 10-second point cloud video is approximately 0.7 million×(4 Byte×3+1 Byte×3)×30 fps×10 s=3.15 GB, where 1 Byte is 10 bits. A data volume of a 10-second 1280×720 two-dimensional video with a YUV sampling format of 4:2:0 and a frame rate of 24 fps is approximately 1280×720×12 bit×24 fps×10 s 0.33 GB, and a data volume of a 10-second two-view three-dimensional video is approximately 0.33×2=0.66 GB. It can be seen that a data volume of a point cloud video is far more than a data volume of a two-dimensional or three-dimensional video with a same length. Therefore, to better implement data management, save server storage space, and reduce transmission traffic and transmission time between servers and clients, point cloud compression becomes a key for promoting development of point cloud industries.

In other words, since a point cloud is a set of massive points, storing the point cloud not only consumes a large amount of memory but also is non-conducive to transmission. In addition, there is no such bandwidth that can support direct transmission of a point cloud in a network layer without compression. Therefore, the point cloud needs to be compressed.

Currently, a point cloud encoding framework that can be used to compress a point cloud may be a geometry-based point cloud compression (G-PCC) encoding and decoding framework or a video-based point cloud compression (V-PCC) encoding and decoding framework provided by the moving picture experts group (MPEG), or may be an AVS-PCC encoding and decoding framework provided by an AVS. The G-PCC encoding and decoding framework may be used to compress a static point cloud of the type 1 and a dynamically acquired point cloud of the type 3, and may be based on a point cloud compression test platform (TMC13). The V-PCC encoding and decoding framework may be used to compress a dynamic point cloud of the type 2, and may be based on a point cloud compression test platform (TMC2). Therefore, the G-PCC encoding and decoding framework is also referred to as a point cloud codec TMC13, and the V-PCC encoding and decoding framework is also referred to as a point cloud codec TMC2.

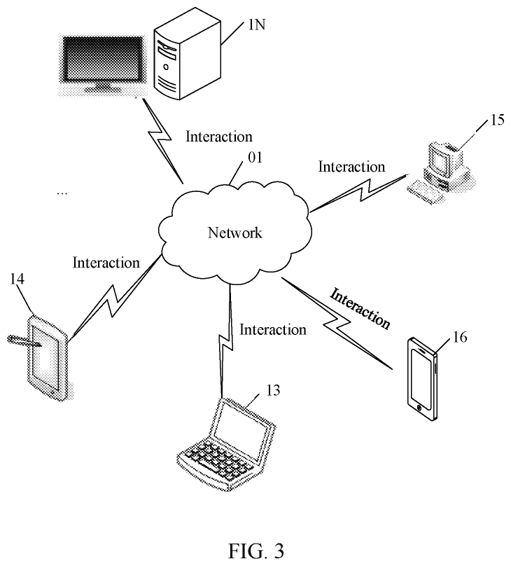

Embodiments of this application provide a network architecture of a point cloud encoding and decoding system including a decoding method and an encoding method. FIG. 3 is a schematic diagram of a network architecture for point cloud encoding and decoding according to an embodiment of this application. As shown in FIG. 3, the network architecture includes one or more electronic devices 13 to 1N and a communications network 01, where the electronic devices 13 to 1N may perform video interaction with each other by using the communications network 01. In an implementation process, the electronic device may be various types of devices that have a point cloud encoding and decoding function. For example, the electronic device may include a mobile phone, a tablet computer, a personal computer, a personal digital assistant, a navigator, a digital telephone, a video telephone, a television, a sensing device, a server, or the like. This is not limited in embodiments of this application. A decoder or an encoder in embodiments of this application may be the foregoing electronic device.

The electronic device in embodiments of this application has a point cloud encoding and decoding function, and generally includes a point cloud encoder (that is, an encoder) or a point cloud decoder (that is, a decoder).

The following describes a related technology by using a G-PCC encoding and decoding framework and an AVS encoding and decoding framework as an example.

It may be understood that, in the G-PCC encoding and decoding framework for a point cloud, to-be-encoded point cloud data is first partitioned into a plurality of slices through slicing. In each slice, geometric information of the point cloud and attribute information corresponding to each point are separately encoded.

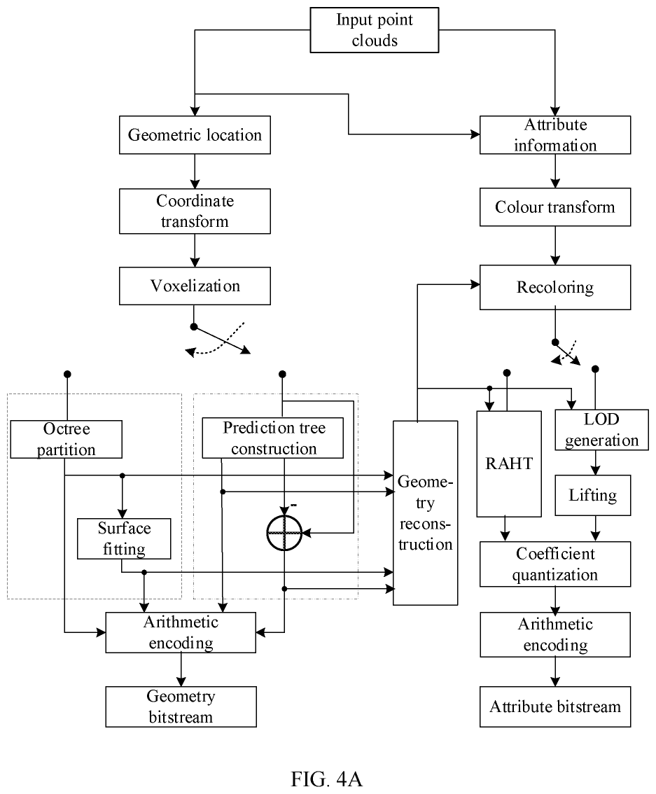

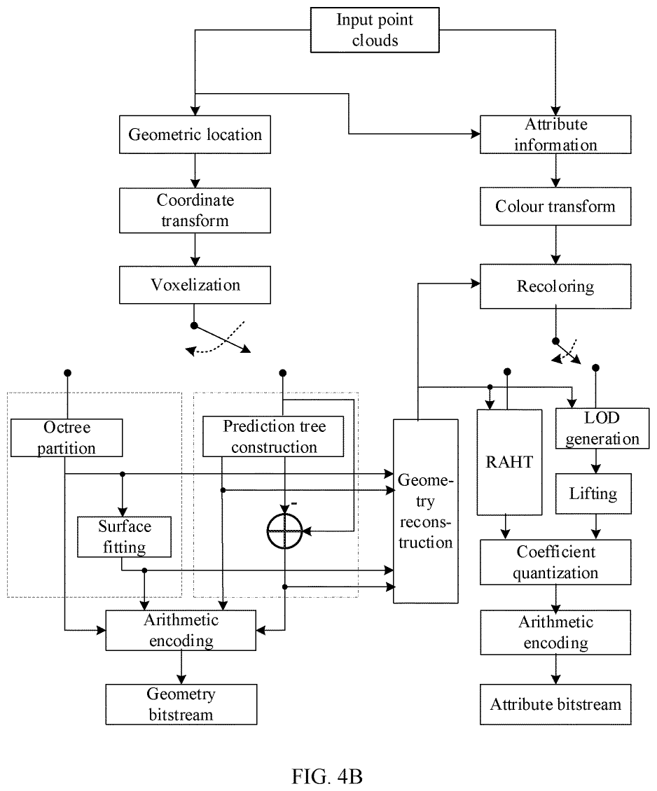

FIG. 4A is a schematic diagram of a framework of a G-PCC encoder. As shown in FIG. 4A, in a geometry encoding process, coordinate transform is performed on geometric information, so that an entire point cloud is included in a bounding box, and then quantization is performed. The quantization in this step mainly plays a role of scaling. Due to rounding in the quantization, a part of the point cloud has same geometric information. Then, whether to remove duplicate points is determined based on a parameter. The process of quantization and removal of duplicate points is also referred to as voxelization. Next, octree partitioning or prediction tree construction is performed on the bounding box. In this process, arithmetic encoding is performed on points in leaf nodes generated by partitioning, to generate a binary geometric bitstream; or arithmetic encoding (surface fitting based on vertices) is performed on vertices generated by partitioning, to generate a binary geometric bitstream. In an attribute encoding process, geometry encoding is already completed. After the geometric information is reconstructed, color transform needs to be performed first, to transform color information (that is, attribute information) from an RGB color space to a YUV color space. Then, the point cloud is colored again by using the reconstructed geometric information, so that attribute information that is not encoded corresponds to the reconstructed geometric information. Attribute encoding is mainly performed on color information. In a color information encoding process, there are mainly two transformation methods: One method is distance-based lifting transform depending on level of detail (LOD) partitioning, and the other method is to directly perform RAHT. In both the two methods, the color information is transformed from a spatial domain to a frequency domain, a high-frequency coefficient and a low-frequency coefficient are obtained by transformation, finally the high-frequency coefficient and the low-frequency coefficient are quantized, and then arithmetic encoding is performed on the quantized coefficients, to generate a binary attribute bitstream.

FIG. 4B is a schematic diagram of a framework of a G-PCC decoder. As shown in FIG. 4B, for an acquired binary bitstream, a geometric bitstream and an attribute bitstream in the binary bitstream are first separately decoded. During decoding of the geometric bitstream, geometric information of the point cloud is obtained through arithmetic decoding-octree reconstruction or prediction tree reconstruction-geometric reconstruction-inverse transform of coordinates. During decoding of the attribute bitstream, attribute information of the point cloud is obtained through arithmetic decoding-inverse quantization-LOD division or RAHT-inverse transform of colors. Based on the geometric information and the attribute information, to-be-encoded point cloud data is restored (that is, the point cloud is outputted).

It should be noted that, as shown in FIG. 4A or FIG. 4B, currently G-PCC geometry encoding and decoding may include octree geometry encoding and decoding (shown in a dashed box) and predictive geometry encoding and decoding (shown in a dash-dotted box).

The octree geometry encoding (OctGeomEnc) includes the following steps. First, coordinate transform is performed on the geometric information, such that the whole point cloud is contained within a bounding box. Then, quantization is performed. The quantization in this step mainly plays a role of scaling. Due to rounding in the quantization, some points have same geometric information. Then, whether to remove duplicate points is determined based on a parameter. The process of quantization and removal of duplicate points is also referred to as voxelization. Next, partitioning of a tree (for example, an octree, a quadtree, or a binary tree) is continuously performed on the bounding box in a breadth-first traversal sequence, and an occupancy code of each node is encoded. In a related technology, a company proposes an implicit geometric partitioning manner. First, a bounding box (2^{d}^{ₓ}, 2^{d}^{_{y}}, 2^{d}^{_{z}}) of a point cloud is calculated. It is assumed that dₓ>d_{y}>d_{z}, and the bounding box is correspondingly a cube. During geometric partitioning, first, binary tree partitioning is continuously performed based on an x-axis, to obtain two child nodes. Only when a condition dₓ=d_{y}>d_{z} is met, quadtree partitioning is continuously performed based on the x-axis and ay-axis, to obtain four child nodes. When a condition dₓ=d_{y}=d_{z} is finally met, octree partitioning is continuously performed until leaf nodes obtained after the partitioning are 1×1×1 unit cubes. Then, points in the leaf nodes are encoded, to generate a binary bitstream. In a process of partitioning based on a binary tree, a quadtree, or an octree, two parameters K and M are introduced. The parameter K indicates a maximum quantity of times of binary tree or quadtree partitioning before octree partitioning, and the parameter M is used to indicate that a side length of a minimum block corresponding to binary tree or quadtree partitioning is 2^{M}. In addition, K and M must meet the following condition: assuming that dₘₐₓ=max (dₓ, d_{y}, d_{z}) and dₘᵢₙ=min(dₓ, d_{y}, d_{z}), the parameter K meets K≥dₘₐₓ−dₘᵢₙ and the parameter M meets M≥dₘᵢₙ. A reason why the parameters K and M meet the foregoing condition is that, in the current implicit geometric partitioning of G-PCC, partitioning manners in descending order of priorities are binary tree partitioning, quadtree partitioning, and octree partitioning. Only when a size of a node block does not meet a condition of binary tree or quadtree partitioning, octree partitioning is continuously performed on the node until leaf nodes of a minimum unit 1×1×1 are obtained. In an octree geometry encoding mode, geometric information of a point cloud may be effectively encoded by using correlation between neighboring points in space. However, for some relatively flat nodes or nodes that have a planar feature, encoding efficiency of the geometric information of the point cloud may be further improved by using plane coding.

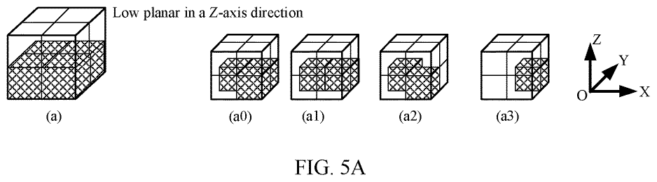

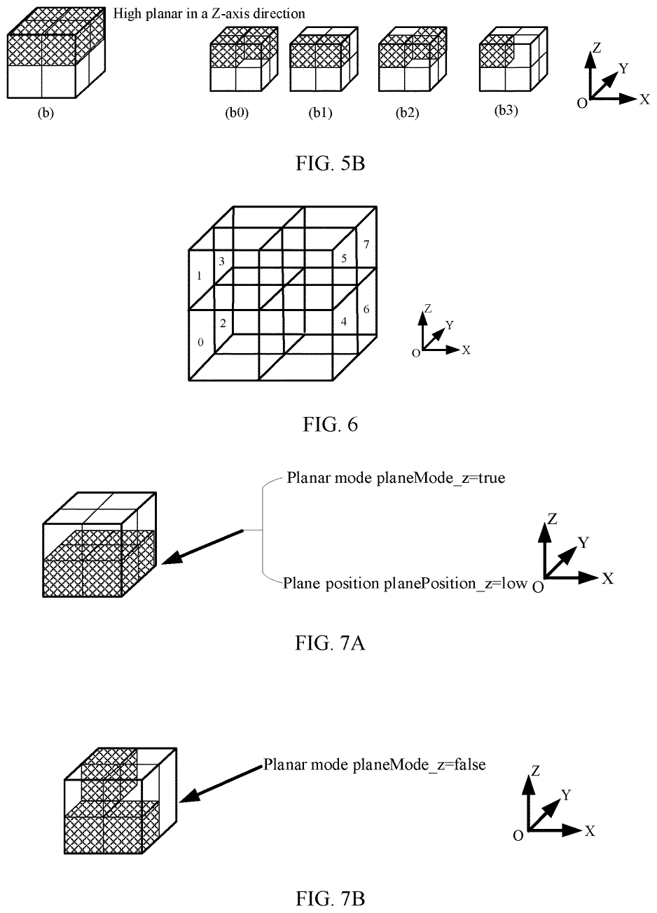

Exemplarily, FIG. 5A and FIG. 5B are schematic diagrams of planar positions. FIG. 5A is a schematic diagram of low planar positions in a Z-axis direction, and FIG. 5B is a schematic diagram of high planar positions in a Z-axis direction. As shown in FIG. 5A, (a), (a0), (a1), (a2), and (a3) herein all belong to low planar positions in a Z-axis direction. By using (a) as an example, it can be seen that four occupied child nodes in a current node are all located in low planar positions in a Z-axis direction of the current node. In this case, it may be considered that the current node belongs to a Z-plane that is a low plane in the Z-axis direction. Similarly, as shown in FIG. 5B, (b), (b0), (b1), (b2), and (b3) herein all belong to high planar positions in a Z-axis direction. By using (b) as an example, it can be seen that four occupied child nodes in a current node are located in high planar positions in a Z-axis direction of the current node. In this case, it may be considered that the current node belongs to a Z-plane that is a high plane in the Z-axis direction.

Further, octree coding efficiency is compared against plane coding efficiency by using (a) in FIG. 5A as an example. FIG. 6 is a schematic diagram of a node coding sequence, that is, node coding is performed in a sequence of 0, 1, 2, 3, 4, 5, 6, and 7 shown in FIG. 6. Herein, if octree coding is used for (a) in FIG. 5A, occupancy information of the current node is represented as 10101010. However, if plane coding is used, first, an identifier needs to be encoded, to indicate that the current node is a plane in the Z-axis direction. Then, if the current node is a plane in the Z-axis direction, a planar position of the current node also needs to be represented. Next, only occupancy information (that is, occupancy information of four child nodes 0, 2, 4, and 6) of low-plane nodes in the Z-axis direction needs to be encoded. Therefore, if the current node is encoded based on plane coding, only six bits need to be encoded. Compared with octree coding in a related technology, plane coding reduces representation by two bits. Based on this analysis, plane coding has more evident coding efficiency than octree coding. Therefore, for an occupied node, if plane coding is performed in a dimension, first, planar mode (planarMode) information and planar position (PlanePos) of the current node in the dimension need to be represented. Then, occupancy information of the current node is encoded based on planar information of the current node. Exemplarily, FIG. 7A is a schematic diagram of a piece of planar mode information. As shown in FIG. 7A, a Z-axis direction herein is a low plane. Correspondingly, a value of planar mode information is true or 1, that is, planarMode_z=true. A value of planar position information is low, that is, PlanePosition_z=low. FIG. 7B is a schematic diagram of another piece of planar mode information. As shown in FIG. 7B, a Z-axis direction herein is not a plane. Correspondingly, a value of planar mode information is false or 0, that is, planarMode_z=false.

It should be noted that for PlaneMode_ᵢ, 0 represents that a current node is not a plane in an i-axis direction, and 1 represents that the current node is a plane in the i-axis direction. If the current node is a plane in the i-axis direction, for PlanePosition_ᵢ, 0 indicates that the current node is a plane in the i-axis direction and has a low planar position, and 1 indicates that the current node is a high plane in the i-axis direction. Herein, i represents a coordinate dimension, which may be an X-axis direction, a Y-axis direction, or a Z-axis direction. Therefore, i=0, 1, or 2.

In a G-PCC standard, whether a node meets a plane coding condition is determined. When the node meets the plane coding condition, predictive encoding is performed on planar mode information and planar position information of the node.

There are three conditions for determining whether a node meets a plane coding condition in a current G-PCC standard. The following describes the conditions in detail one by one.
1. Determine whether a node meets a plane coding condition based on a plane probability of the node in each dimension.
(1) Determine a local node density (local_node_density) of the current node.
(2) Determine a probability Prob(i) of the current node in each dimension.

When the local node density of the node is less than a threshold value Th (for example, Th=3), a plane probability Pro(i) of the current node in three coordinate dimensions is compared against thresholds Th0, Th1, and Th2, where Th0<Th1<Th2 (for example, Th0=0.6, Th1=0.77, and Th2=0.88). Herein, Eligibleᵢ(i=0,1,2) may be used to indicate whether to enable plane coding in each dimension: Eligibleᵢ=Prob(i)≥threshold.

It should be noted that a threshold changes adaptively. For example, when Prob(0)>Prob(1)>Prob(2), Eligibleᵢ is set as follows:

$${Eligible}_{0} = Prob ( 0 ) \geq Th 0 ; \qquad ( 1 )$$

$${Eligible}_{1} = Prob ( 1 ) \geq Th 1 ;$$

$${Eligible}_{2} = Prob ( 2 ) \geq Th 2$$

When Prob(1)>Prob(0)>Prob(2), Eligibleᵢ is set as follows:

$${Eligible}_{0} = Prob ( 0 ) \geq Th 1 ; \qquad ( 2 )$$

$${Eligible}_{1} = Prob ( 1 ) \geq Th 0 ;$$

$${Eligible}_{2} = Prob ( 2 ) \geq Th 2$$

Herein, Prob(i) is updated specifically as follows:

$${Prob ( i )}_{new} = ( L \times Prob ( i ) + δ ( code node ) ) / L + 1 \qquad ( 3 )$$

Herein, L=255. In addition, if a coded node is a plane, δ(coded node) is 1. Otherwise, δ(coded node) is 0.

Herein, local_node_density is updated specifically as follows:

$$local\_node {\_density}_{new} = local\_node \_density + 4 * numSiblings \qquad ( 4 )$$

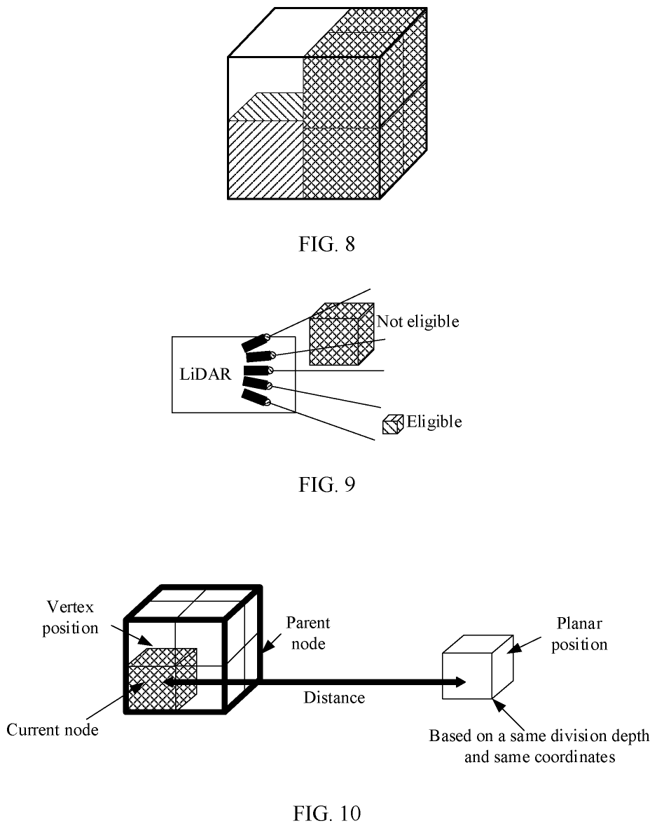

Herein, local_node_density is initialized to 4, and numSiblings is a quantity of sibling nodes of the node. Exemplarily, FIG. 8 is a schematic diagram of sibling nodes of a current node. As shown in FIG. 8, if the current node is a node filled with slanting lines, and nodes filled with grids are sibling nodes of the current node, a quantity of the sibling nodes of the current node is 5 (including the current node).
2. Determine, based on a point cloud density of a current layer, whether a node in the current layer meets a plane coding condition.

Density of points in the current layer is used to determine whether to perform plane encoding on the node at the current layer. A quantity of points in a currently to-be-encoded point cloud is represented as pointCount, and a quantity of points that have been reconstructed through infer direct coding model (IDCM) coding is represented as numPointCountRecon. In addition, because octree coding is performed based on a breadth-first traversal sequence, a quantity of to-be-encoded nodes in the current layer, which is represented as nodeCount, may be obtained. In this case, whether plane coding is enabled for the current layer is represented as planarEligibleKOctreeDepth, which is determined specifically as planarEligibleKOctreeDepth=(pointCount−numPointCountRecon)<nodeCount×1.3.

If (pointCount−numPointCountRecon) is less than nodeCount×1.3, planarEligibleKOctreeDepth is true, or if (pointCount−numPointCountRecon) is not less than nodeCount×1.3, planarEligibleKOctreeDepth is false. In this way, when planarEligibleKOctreeDepth is true, plane coding is performed on all nodes in the current layer. Otherwise, plane coding is not performed on any node in the current layer, and only octree coding is used.
3. Determine, based on a collection parameter of a LiDAR point cloud, whether a current node meets a plane coding condition.

FIG. 9 is a schematic diagram of intersection between lasers of a LiDAR device and a node. As shown in FIG. 9, a grid-filled node is simultaneously passed through by rays of two lasers. Therefore, a current node is not a plane in a vertical Z-axis direction. A node filled with slanting lines is so small that the node cannot be simultaneously passed through by rays of two lasers. Therefore, the node filled with slanting lines may be a plane in the vertical Z-axis direction.

Further, for a node that meets a plane coding condition, predictive encoding may be performed on planar mode information and planar position information.

First, predictive encoding is performed on the planar mode information.

Herein, only three pieces of context information are used for encoding, that is, context is designed separately for a planar mode in each coordinate dimension.

Second, predictive encoding is performed on the planar position information.

It should be understood that, for encoding of planar position information of a non-LiDAR point cloud, predictive encoding of the planar position information may include:
(a) planar position information of the current node that is obtained through prediction by using occupancy information of the neighboring node, which includes three elements, that is, being predicted as a low plane, being predicted as a high plane, and being unpredictable;
(b) the spatial distance between the current node and the node at the same partitioning depth and the same coordinate as the current node, which is “short” or “long”;
(c) a planar position of the node at the same partitioning depth and the same coordinate as the current node, determined if the node is a plane; and
(d) coordinate dimensions (i=0, 1, 2).

It should be noted that, in embodiments of this application, after the spatial distance between the current node and the node under the same division depth and the same coordinates as the current node is determined, if the spatial distance is less than a preset distance threshold, it may be determined that the spatial distance is “short”. Alternatively, if the spatial distance is greater than the preset distance threshold, it may be determined that the spatial distance is “long”.

Exemplarily, FIG. 10 is a schematic diagram of a neighboring node at a same division depth and a same coordinate. As shown in FIG. 10, a bold large cube represents a parent node, a grid-filled small cube inside the large cube represents a current node, and a vertex position of the current node is shown. A small cube filled with the white color represents a neighboring node at a same division depth and a same coordinate. A distance between the current node and the neighboring node is a spatial distance, which may be determined as “short” or “long”. In addition, if the neighboring node is a plane, a planar position of the neighboring node is also required.

In this way, as shown in FIG. 10, the current node is a grid-filled small cube, and a neighboring node is searched at a same octree division depth level and a same vertical coordinate. The found neighboring node is a small cube filled with the white color. It is determined that a distance between the two nodes is “short” or “long”, and reference is made to planar positions of the nodes.

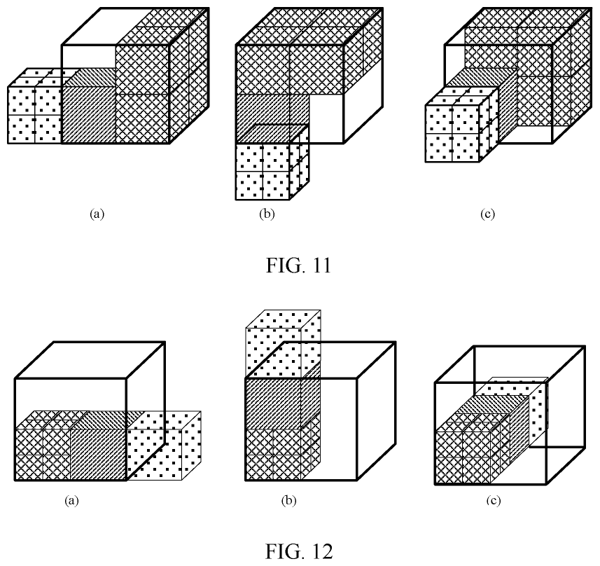

Further, in embodiments of this application, FIG. 11 is a schematic diagram showing that a current node is located on a low plane of a parent node. As shown in FIG. 11, (a), (b), and (c) show examples of three cases in which the current node is located on a low plane of the parent node. Detailed descriptions are as follows.
\textcircled{1} If any one of child nodes 4 to 7 of a point-filled node is occupied, and none of grid-filled nodes is occupied, it is very likely that a plane exists in the current node (filled with slanting lines), and a position of the plane is relatively low.
\textcircled{2} If none of child nodes 4 to 7 of a point-filled node is occupied, and all grid-filled nodes are occupied, it is very likely that a plane exists in the current node (filled with slanting lines), and a position of the plane is relatively high.
\textcircled{3} If all child nodes 4 to 7 of a point-filled node are empty nodes, and all grid-filled nodes are empty nodes, a position of the plane cannot be inferred and therefore is marked as unknown.
\textcircled{4} If any one of child nodes 4 to 7 of a point-filled node is occupied, and any one of grid-filled nodes is occupied, a position of the plane cannot be inferred and therefore is marked as unknown.

In embodiments of this application, FIG. 12 is a schematic diagram showing that a current node is located on a high plane of a parent node. As shown in FIG. 12, (a), (b), and (c) show examples of three cases in which the current node is located on a high plane of the parent node. Detailed descriptions are as follows.
\textcircled{1} If any one of child nodes 4 to 7 of a grid-filled node is occupied, and a point-filled node is not occupied, it is very likely that a plane exists in the current node (filled with slanting lines), and a position of the plane is relatively low.
\textcircled{2} If none of child nodes 4 to 7 of a grid-filled node is not occupied, and a point-filled node is occupied, it is very likely that a plane exists in the current node (filled with slanting lines), and a position of the plane is relatively high.
\textcircled{3} If none of child nodes 4 to 7 of a grid-filled node is not occupied, and a point-filled node is not occupied, a position of the plane cannot be inferred and therefore is marked as unknown.
\textcircled{4} If one of child nodes 4 to 7 of a grid-filled node is occupied, and a point-filled node is occupied, a position of the plane cannot be inferred and therefore is marked as unknown.

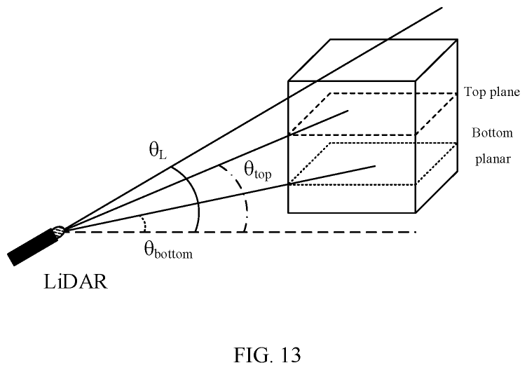

It should be further understood that, for encoding of planar position information of a LiDAR point cloud, FIG. 13 is a schematic diagram of predictive encoding of planar position information of a LiDAR point cloud. As shown in FIG. 13, in a case in which an emission angle of a LiDAR device is θ_{bottom}, it may be mapped to a bottom plane, or in a case in which the emission angle of the LiDAR device is θₜₒₚ, it may be mapped to a top plane (top virtual plane).

In other words, a planar position of a current node is predicted by using a collection parameter of the LiDAR device. Then, the position is quantized into a plurality of intervals by using a position at which the current node intersects a laser ray, and finally serves as context information of the planar position of the current node. A specific calculation process is as follows. Assuming that coordinates of the LiDAR device are (x_{Lidar}, y_{Lidar}, z_{Lidar}) and geometric coordinates of the current node are (x, y, z), first, a vertical tangent value tan 0 of the current node relative to the LiDAR device is calculated by using the following formula:

$$tan θ = \frac{z - {z}_{Lidar}}{\sqrt{{( x - {x}_{Lidar} )}^{2} + {( y - {y}_{Lidar} )}^{2}}} \qquad ( 5 )$$

Further, because each laser has a deflection angle relative to the LiDAR device, a relative tangent value tan θ_{corr,L} of the current node relative to the laser also needs to be calculated. A calculation manner is as follows:

$$tan {θ}_{corr , L} = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r} \qquad ( 6 )$$

Finally, the relative tangent value tan θ_{corr,L} of the current node is used to predict the planar position of the current node. Specifically, it is assumed that a tangent value of a lower boundary of the current node is tan(θ_{bottom}), and a tangent value of an upper boundary of the current node is tan(θₜₒₚ). The planar position is quantized into four quantization intervals according to tan θ_{corr,L}, that is, context information of the planar position is determined.

However, the octree geometry encoding mode has an efficient compression rate only for points that are correlated in space. For a point that is in an isolated position in a geometric space, complexity may be greatly reduced by using a direct coding model (DCM). For all nodes in an octree, usage of the DCM is not represented by flag information, but is inferred by using information about a parent node and a neighbor of a current node. Whether the current node is eligible for DCM coding is determined in the following three manners.
(1) The current node has no sibling nodes, that is, the parent node of the current node has only one child node, and a parent node of the parent node of the current node has only two occupied child nodes, that is, the current node has a maximum of one neighboring node.
(2) The parent node of the current node has only one occupied child node, that is, the current node, and six neighboring nodes that each share a face with the current node are all empty nodes.
(3) A quantity of sibling nodes of the current node is greater than 1.

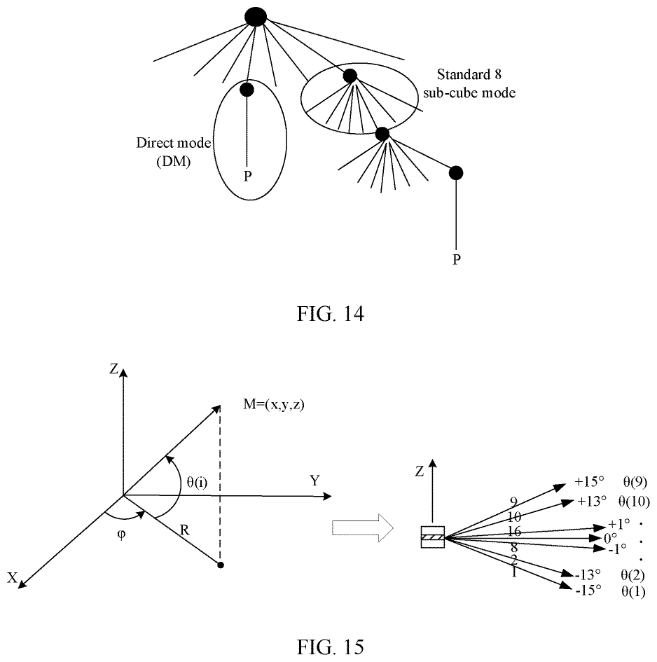

Exemplarily, FIG. 14 is a schematic diagram of IDCM coding. If a current node is not eligible for DCM coding, octree partitioning is performed on the current node. If the current node is eligible for DCM coding, a quantity of points included in the node is further determined. If the quantity of points is less than a threshold (for example, 2), DCM coding is performed on the node. Otherwise, octree partitioning is continued. When the DCM coding mode is applied, first, it needs to be encoded whether the current node is a real isolated point, that is, IDCM_flag. When IDCM_flag is true, DCM coding is used for the current node. Otherwise, octree coding is still used. When the current node meets a DCM coding condition, a DCM coding mode needs to be encoded for the current node. Currently, there are two DCM modes: (a) There is only one point (or a plurality of points that are duplicate points); (b) There are two points. Finally, geometric information of each point needs to be encoded. Assuming that an edge length of a node is 2^{d}, d bits are required for encoding each component of geometric coordinates of the node, and the bit information is directly encoded into a bitstream. It should be noted herein that, when a LiDAR point cloud is encoded, predictive encoding is performed on coordinate information in three dimensions by using a LiDAR collection parameter, thereby further improving encoding efficiency of geometric information.

Further, the following describes in detail an IDCM coding process.

When a current node meets a DCM coding condition, first, a quantity numPoints of points in the current node is encoded according to different values of DirectMode.
(1) If the current node does not meet a requirement of a DCM node, the encoding is not performed (that is, the quantity of points is greater than 2 and the points are not duplicate).
(2) If the quantity numPonts of the points included in the current node is less than or equal to 2, the encoding process is as follows.
   i) First, whether numPonts of the current node is greater than 1 is encoded.
   ii) If the current node has only one point and a geometric coding environment is geometric lossless coding, that the second point of the current node is not a duplicate point needs to be encoded.
(3) If the quantity numPonts of the points included in the current node is greater than 2, the encoding process is as follows.
   i) First, that numPonts of the current node is less than or equal to 1 is encoded.
   ii) Then, that the second point of the current node is a duplicate point is encoded, and whether a quantity of duplicate points in the current node is greater than 1 is encoded. If the quantity of the duplicate points is greater than 1, exponential-Golomb decoding needs to be performed on a quantity of remaining duplicate points.

After the quantity of the points in the current node is encoded, coordinate information of the points included in the current node is encoded. The following separately describes a LiDAR point cloud and a human eye point cloud.

### 1. For a Human Eye Point Cloud:

(1) If a current node includes only one point, bypass encoding is performed on geometric information in three dimensions of the point.
(2) If a current node includes two points, first, a preferentially encoded coordinate axis dirextAxis is obtained by using geometric coordinates of the points. It should be noted herein that currently compared coordinate axes include only an x-axis and a y-axis, and do not include a z-axis. Assuming that geometric coordinates of the current node are nodePos, a manner of determining is as follows:

$$dirextAxis = ! ( nodePos [ 0 ] < nodePos [ 1 ] )$$

That is, an axis with a small geometric coordinate position of the node is used as the preferentially encoded coordinate axis dirextAxis. Then, geometric information of the preferentially encoded coordinate axis dirextAxis is first encoded in the following manner. It is assumed that a to-be-encoded geometry bit depth corresponding to the preferentially encoded axis is nodeSizeLog2, and coordinates of the two points are respectively pointPos[0] and pointPos[1]. A specific encoding process is as follows:

```
  Bool sameBit=true;
  while(nodeSizeLog2&& sameBit){
    int mask=1<< nodeSizeLog2;
    −−nodeSizeLog2;
    bool bit0=!!( pointPos[0]& mask)
bool bit1=!!( pointPos[1]& mask)
    sameBits=bit0==bit1;
    entropyCodeSameBit(sameBits); ///<entropy coding
    if(sameBits)
      encodePosBit(bit0);///<Bypass coding
    }
```

After the preferentially encoded coordinate axis dirextAxis is encoded, bypass encoding is performed on the geometric coordinates of the current node. Assuming that a remaining coding bit depth of each point is nodeSizeLog2, a specific encoding process is as follows:

for(int axisIdx=0;axisIdx<3;++axisIdx)
for(int mask=(1<< nodeSizeLog2[axisIdx])>>1;mask;mask>>1)
encodePosBit(!!(pointPos[axisIdx]&mask)).

### 2. For a LiDAR Point Cloud:

If a current node includes two points, first, a preferentially encoded coordinate axis dirextAxis is obtained by using geometric coordinates of the points. It is assumed that geometric coordinates of the current node are nodePos, and a manner of determining is as follows:

$$dirextAxis = ! ( nodePos [ 0 ] < nodePos [ 1 ] )$$

That is, an axis with a small geometric coordinate position of the node is used as the preferentially encoded coordinate axis dirextAxis. It should be noted herein that currently compared coordinate axes include only an x-axis and a y-axis, and do not include a z-axis. Then, geometric information of the preferentially encoded coordinate axis dirextAxis is first encoded in the following manner. It is assumed that a to-be-encoded geometry bit depth corresponding to the preferentially encoded axis is nodeSizeLog2, and coordinates of the two points are respectively pointPos[0] and pointPos[1]. A specific encoding process is as follows:

```
Bool sameBit=true;
while(nodeSizeLog2&& sameBit){
    int mask=1<< nodeSizeLog2;
    −−nodeSizeLog2;
    bool bit0=!!( pointPos[0]& mask)
  bool bit1=!!( pointPos[1]& mask)
    sameBits=bit0==bit1;
    entropyCodeSameBit(sameBits);
    if(sameBits)
      encodePosBit(bit0);
    }
```

After the preferentially encoded coordinate axis dirextAxis is encoded, the geometric coordinates of the current node are encoded.

A LiDAR point cloud may obtain a collection parameter of the LiDAR point cloud, and geometric coordinate information of the current node may be predicted by using the collection parameter, so that encoding efficiency of geometric information of the point cloud may be further improved. Similarly, first, a principal direction in which bypass encoding is performed is obtained by using geometric information nodePos of the current node, and then geometric information of a direction in which encoding is completed is used to perform predictive encoding on geometric information of another dimension. Similarly, assuming that an axial direction in which bypass encoding is performed is directAxis and a to-be-encoded bit depth in the bypass encoding is nodeSizeLog2, an encoding manner is as follows:

for(int mask=(1<< nodeSizeLog2)>>1;mask;mask>>1)
encodePosBit(!!(pointPos[directAxis]&mask)).

It should be noted herein that all geometric precision information in the direction directAxis is encoded herein.

Exemplarily, FIG. 15 is a schematic diagram of coordinate transform of a point cloud acquired by a rotating LiDAR device. In a Cartesian coordinate system, coordinates (x, y, z) of each node may be transformed into coordinates (R, φ, i). In addition, a laser scanner may perform laser scanning at a preset angle. Different values of i yield different θ(i). For example, when i is equal to 1, θ(1) may be obtained, and a corresponding scanning angle is −15°. When i is equal to 2. θ(2) may be obtained, and a corresponding scanning angle is −13°. When i is equal to 10, θ(10) may be obtained, and a corresponding scanning angle is +13°. When i is equal to 9, θ(19) may be obtained, and a corresponding scanning angle is +15°.

In this case, after all precision values in a coordinate direction directAxis are encoded, first, LaserIdx corresponding to a current node, that is, pointLaserIdx in FIG. 15, is calculated, and LaserIdx of a current node, that is, nodeLaserIdx, is calculated. Then, LaserIdx of the node, that is, nodeLaserIdx, is used to perform predictive encoding on LaserIdx of the point, that is, pointLaserIdx. LaserIdx of the node or the point is calculated in the following manner: Assuming that a geometric coordinate of a point is pointPos, a start coordinate of a laser ray is LidarOrigin, a quantity of Laser is LaserNum, a tangent value of each Laser is tan θᵢ, and an offset position of each Laser in a vertical direction is Zi,

```
      Int bestLaserIdx=0;
      Int Distoration=INT_MAX;
  For(int LaserIdx=0; LaserIdx<numLaser;++ LaserIdx){
int radius = ({square root over (pointPos[0]   darOrigin[0])2 + (pointPos[1] − LidarOrigin[1])2)}
      int invRadius=1/ radius
      int Z=pointPos[2]+ Zᵢ
      int tanTheta= Z×invRadius
      if(std::abs(tanTheta-tanθᵢ)< Distoration){
      Distoration= std::abs(tanTheta-tanθᵢ);
      bestLaserIdx= LaserIdx;
      }
    }
```

After LaserIdx of the current node is calculated, first, predictive encoding is performed on pointLaserIdx of the point by using LaserIdx of the current node. After LaserIdx of the current node is encoded, predictive encoding is performed on geometric information of three dimensions of the current node by using a collection parameter of the LiDAR device.

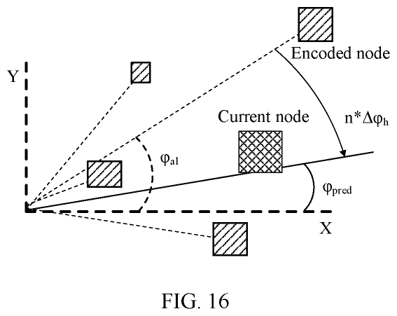

Exemplarily, FIG. 16 is a schematic diagram of predictive encoding in an X-axis or Y-axis direction. As shown in FIG. 16, a grid-filled box represents a current point, and a box filled with slanting lines represents an encoded point (already coded node). Herein, first, a predicted value, that is, φ_{pred}, of a corresponding horizontal azimuth is obtained by using LaserIdx corresponding to a current node, and then a horizontal azimuth φ_{node} corresponding to a node is obtained by using node geometric information corresponding to the current point. Assuming that the geometric coordinates of the node are nodePos, a manner of calculating a horizontal azimuth φ by using the geometric information of the node is as follows:

$$φ = arctan ( nodePos [ 1 ] / nodePos [ 0 ] ) \qquad ( 7 )$$

The collection parameter of the LiDAR device may be used to obtain a quantity numPoints of rotation points of each laser, that is, a quantity of points obtained after each laser ray rotates by one circle. In this case, the quantity of rotation points of each laser may be used to calculate a rotational angular velocity deltaPhi of each laser. A calculation manner is as follows:

$$deltaPhi = \frac{2 π}{numPoints} \qquad ( 8 )$$

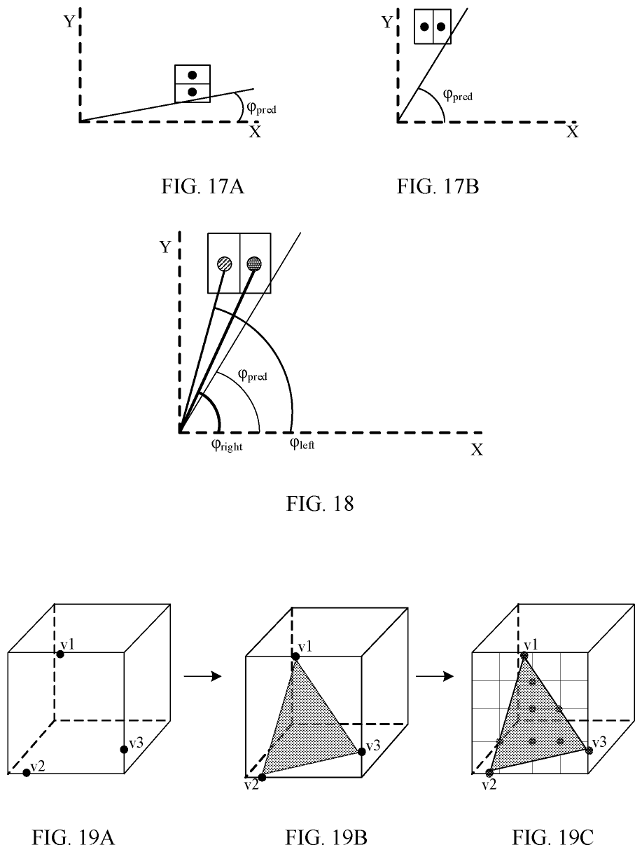

Further, the horizontal azimuth φ_{node} of the node and a horizontal azimuth φ_{pred} of a previous encoding point of a laser corresponding to the current point are used to calculate a predicted value φ_{predPoint} of the horizontal azimuth corresponding to the current point, for example, a predicted value of a horizontal azimuth in FIG. 17A and FIG. 17B. FIG. 17A is a schematic diagram of an angle for predicting a Y plane by using a horizontal azimuth, and FIG. 17B is a schematic diagram of an angle for predicting an X plane by using a horizontal azimuth. Herein, the predicted value φ_{predPoint} of the horizontal azimuth corresponding to the current node is calculated as follows:

$${φ}_{predPoint} = \frac{φ pred - φ node}{deltaPhi} \times deltaPhi + φ pred \qquad ( 9 )$$

Exemplarily, FIG. 18 is another schematic diagram of predictive encoding in an X-axis or Y-axis direction. As shown in FIG. 18, a grid-filled part (on the left) represents a low plane, a dot-filled part (on the right) represents a high plane, φ_{left} represents a low-plane horizontal azimuth of a current node, φ_{right} represents a high-plane horizontal azimuth of the current node, and φ_{pred} represents a predicted value of a horizontal azimuth corresponding to the current node.

In this way, predictive encoding is performed on geometric information of the current node by using the predicted value φ_{predPoint} of the horizontal azimuth, the low-plane horizontal azimuth φ_{left} of the current node, and the high-plane horizontal azimuth φ_{right} of the current node. Details are as follows:

int angLel = φ_{left} − φ_{pred};
int angLeR = φ_{right} − φ_{pred};
int context = (angLel ≥ 0&&angLeR ≥ 0)||(angLel < 0&&angLeR < 0)? 0: 2;
int minAngle = std :: min(abs(angLel), abs(angLeR));
int maxAngle = std :: max(abs(angLel), abs(angLeR));
context+= maxAngle > minAngle? 0: 1;
context+= maxAngle > minAngle? 0: 4.

After LaserIdx of a point is encoded, predictive encoding is performed on a Z-axis direction of the current node by using LaserIdx corresponding to the current node. That is, currently, radius information radius of a radar coordinate system is calculated by using x and y information of the current node. Then, a tangent value of the current node and an offset in a vertical direction are obtained by using LiDAR LaserIdx of the current node. In this case, a predicted value, that is, Z_pred, of the current node in the Z-axis direction may be obtained. Details are as follows:

int radius = ({square root over (pointPos[0] − LidarOrigin[0]) [symbol] (pointPos[1] − LidarOrigin[1]) ²)};
int tanTheta= tanθ_{laserIdx};
int zOffset= Z_{laserIdx}; and
Z_pred= radius ×tanTheta − zOffset.

Further, Z_pred is used to perform predictive encoding on geometric information in the Z-axis direction of the current node, to obtain a prediction residual Z_res, and Z_res is encoded.

It should be noted that, when a node is divided into leaf nodes, in a case of lossless geometry encoding, a quantity of duplicate points in the leaf nodes needs to be encoded. Finally, occupancy information of all nodes is encoded to generate a binary bitstream. In addition, currently a plane coding mode is introduced into G-PCC. In a process of geometric partitioning, it is determined whether child nodes of a current node are on a same plane. If the child nodes of the current node meet a condition of being on the same plane, the plane is used to represent the child nodes of the current node.

For octree geometry decoding, in a breadth-first traversal sequence, before decoding occupancy information of each node, the decoding end first determines, by using reconstructed geometric information, whether to perform planar decoding or IDCM decoding on a current node. If the current node meets a condition of planar decoding, the decoding end first decodes planar mode information and planar position information of the current node, and then decodes, based on planar information, occupancy information of the current node. If the current node meets a condition of IDCM decoding, the decoding end first decodes whether the current node is a real IDCM node. If the current node is a real IDCM node, the decoding end parses a DCM decoding mode of the current node, and then may obtain a quantity of points in the current DCM node. Finally, the decoding end decodes geometric information of each point. For a node that meets neither plane decoding nor DCM decoding, occupancy information of the current node is decoded. In this manner, an occupancy code of each node is obtained through continuous parsing, and nodes are successively divided until 1×1×1 unit cubes are obtained. A quantity of points included in each leaf node is obtained through parsing, and finally, reconstructed geometric information of a point cloud is restored.

The following describes a process of IDCM decoding in detail.

The processing is similar to that on the encoding end. First, whether an IDCM is enabled for a node is determined by using priori information. That is, a condition for enabling the IDCM is as follows.
(1) The current node has no sibling nodes, that is, the parent node of the current node has only one child node, and a parent node of the parent node of the current node has only two occupied child nodes, that is, the current node has a maximum of one neighboring node.
(2) The parent node of the current node has only one occupied child node, that is, the current node, and six neighboring nodes that each share a face with the current node are all empty nodes.
(3) A quantity of sibling nodes of the current node is greater than 1.

Further, when the node meets a DCM encoding condition, first, whether the current node is a real DCM node, that is, IDCM_flag, is decoded. When IDCM flag is true, DCM encoding is used for the current node. Otherwise, octree encoding is still used.

Then, a quantity numPoints of points of the current node is decoded. A specific decoding manner is as follows.
i) First, whether numPonts of the current node is greater than 1 is decoded.
ii) If it is obtained through the decoding that numPonts of the current node is greater than 1, whether the second point is a duplicate point is decoded. If the second point is not a duplicate point, it may be implicitly deduced herein that the second type of the DCM mode is met, that is, only two points are included.
iii) If it is obtained through the decoding that numPonts of the current node is less than or equal to 1, whether the second point is a duplicate point is decoded. If the second point is not a duplicate point, it may be implicitly deduced herein that the second type of the DCM mode is met, that is, only one point is included. If it is obtained through the decoding that the second point is a duplicate point, it may be inferred that the third type of the DCM mode is met, that is, a plurality of points are included but are all duplicate points. In this case, whether a quantity of the duplicate points is greater than 1 is decoded (entropy decoding). If the quantity is greater than 1, a quantity of remaining duplicate points is decoded (by using exponential-Golomb decoding).

If the current node does not meet a requirement of a DCM node, the encoding is not performed (that is, the quantity of points is greater than 2 and the points are not duplicate).

After the quantity of the points in the current node is decoded, coordinate information of the points included in the current node is decoded. The following separately describes a LiDAR point cloud and a human eye point cloud.

### 1. For a Human Eye Point Cloud:

(1) If a current node includes only one point, bypass decoding is performed on geometric information in three dimensions of the point.
(2) If the current node includes two points, first, a preferentially decoded coordinate axis dirextAxis is obtained by using geometric coordinates of the points. It should be noted herein that currently compared coordinate axes include only an x-axis and a y-axis, and do not include a z-axis. Assuming that geometric coordinates of the current node are nodePos, a manner of determining is as follows:

$$dirextAxis = ! ( nodePos [ 0 ] < nodePos [ 1 ] ) \qquad ( 10 )$$

That is, an axis with a small geometric coordinate position of the node is used as the preferentially decoded coordinate axis dirextAxis. Then, geometric information of the preferentially decoded coordinate axis dirextAxis is first decoded in the following manner. It is assumed that a to-be-decoded geometry bit depth corresponding to the preferentially decoded axis is nodeSizeLog2, and coordinates of the two points are respectively pointPos[0] and pointPos[1]. A specific encoding process is as follows:

```
Bool sameBit=true;
while(nodeSizeLog2&& sameBit){
  pointPos[0][ dirextAxis]<<1;
  pointPos[1][ dirextAxis]<<1;
  −−nodeSizeLog2;
      int bit=0;
      deEntropyCodeSameBit(sameBits); ///<entropy coding
      if(sameBits){
        bit =decodePosBit( );///<Bypass coding
        pointPos[0][ dirextAxis]|= bit
        pointPos[1][ dirextAxis]|= bit
      }else
        pointPos[1][ dirextAxis]|= 1///< Because the two points are sorted in
      sequence in a direction of a preferentially encoded axis during encoding,
      pointPos[0][dirextAxis] < pointPos[1][dirextAxis] may be ensured.
      Therefore, during decoding, if bit information of the two points is different
      from each other, it may be inferred that a bit of the first point is 0 and a bit
      of the second point is 1.
    }
```

After the preferentially decoded coordinate axis dirextAxis is decoded, bypass decoding is performed on the geometric coordinates of the current node. Assuming that a remaining coding bit depth of each point is nodeSizeLog2, and assuming that coordinate information of the point is pointPos, a specific decoding process is as follows:

```
for(int axisIdx=0;axisIdx<3;++axisIdx)
for(int idx= nodeSizeLog2[axisIdx]; idx; idx−−){
    pointPos[axisIdx]<<1;
    pointPos[axisIdx]|=decodePosBit( );
  }
```

### 2. For a LiDAR Point Cloud:

If a current node includes two points, first, a preferentially decoded coordinate axis dirextAxis is obtained by using geometric coordinates of the points. It is assumed that geometric coordinates of the current node are nodePos, and a manner of determining is as follows:

$$dirextAxis = ! ( nodePos [ 0 ] < nodePos [ 1 ] ) \qquad ( 11 )$$

That is, an axis with a small geometric coordinate position of the node is used as the preferentially decoded coordinate axis dirextAxis. It should be noted herein that currently compared coordinate axes include only an x-axis and a y-axis, and do not include a z-axis. Then, geometric information of the preferentially encoded coordinate axis dirextAxis is first decoded in the following manner. It is assumed that a to-be-encoded geometry bit depth corresponding to the preferentially decoded axis is nodeSizeLog2, and coordinates of the two points are respectively pointPos[0] and pointPos[1]. A specific encoding process is as follows:

```
Bool sameBit=true;
while(nodeSizeLog2&& sameBit){
  pointPos[0][ dirextAxis]<<1;
  pointPos[1][ dirextAxis]<<1;
      −−nodeSizeLog2;
      int bit=0;
      deEntropyCodeSameBit(sameBits); ///<entropy coding
      if(sameBits){
        bit =decodePosBit( );///<Bypass coding
        pointPos[0][ dirextAxis]|= bit
        pointPos[1][ dirextAxis]|= bit
      }else
        pointPos[1][ dirextAxis]|= 1///< Because the two points are sorted in
      sequence in a direction of a preferentially encoded axis during encoding,
      pointPos[0][dirextAxis] < pointPos[1][dirextAxis] may be ensured.
      Therefore, during decoding, if bit information of the two points is different
      from each other, it may be inferred that a bit of the first point is 0 and a bit
      of the second point is 1.
    }
```

After the preferentially decoded coordinate axis dirextAxis is decoded, decoding is performed on the geometric coordinates of the current node.

Similarly, first, a principal direction in which bypass decoding is performed is obtained by using geometric information nodePos of the current node, and then geometric information of a direction in which decoding is completed is used to decode geometric information of another dimension. Similarly, assuming that an axial direction in which bypass decoding is performed is directAxis and a to-be-decoded bit depth in the bypass decoding is nodeSizeLog2, a decoding manner is as follows:

```
for(int idx= nodeSizeLog2[directAxis]; idx; idx−−){
    pointPos[directAxis]<<1;
    pointPos[directAxis]|=decodePosBit( );
  }
```

It should be noted herein that all geometric precision information in the direction directAxis is decoded herein.

After all precision values in a coordinate direction directAxis are decoded, first, LaserIdx of a current node, that is, nodeLaserIdx, is calculated. Then, LaserIdx of the node, that is, nodeLaserIdx, is used to perform predictive decoding on LaserIdx of a point, that is, pointLaserIdx. LaserIdx of the node or the point is calculated in the same manner as the encoding end. Finally, prediction residual information of LaserIdx of the current node and prediction residual information of LaserIdx of the node are decoded, to obtain ResLaserIdx. A decoding manner is as follows:

$$PointLaserIdx = nodeLaserIdx + ResLaserIdx \qquad ( 12 )$$

After LaserIdx of the current node is decoded, predictive decoding is performed on geometric information of three dimensions of the current node by using a collection parameter of the LiDAR device. A specific algorithm is as follows.

As shown in FIG. 11, first, a predicted value, that is, φ_{pred}, of a corresponding horizontal azimuth is obtained by using LaserIdx corresponding to a current node, and then a horizontal azimuth φ_{node} corresponding to a node corresponding to the current node is obtained by using geometric information of the node. Assuming that the geometric coordinates of the node are nodePos, a manner of calculating a horizontal azimuth cp by using the geometric information of the node is as follows:

$$φ = arctan ( nodePos [ 1 ] / nodePos [ 0 ] ) \qquad ( 13 )$$

The collection parameter of the LiDAR device may be used to obtain a quantity numPoints of rotation points of each laser, that is, a quantity of points obtained after each laser ray rotates by one circle. In this case, the quantity of rotation points of each laser may be used to calculate a rotational angular velocity deltaPhi of each laser. A calculation manner is as follows:

$$deltaPhi = \frac{2 π}{numPoints} \qquad ( 14 )$$

Further, the horizontal azimuth φ_{node} of the node and a horizontal azimuth φ_{pred} of a previous encoding point of a laser corresponding to the current point are used to calculate a predicted value φ_{predPoint} of the horizontal azimuth corresponding to the current point, for example, predicted values of horizontal azimuths in FIG. 17A and FIG. 17B. A calculation manner is as follows:

$${φ}_{predPoint} = \frac{φ pred - φ node}{deltaPhi} \times deltaPhi + φ pred \qquad ( 15 )$$

In this way, predictive decoding is performed on geometric information of the current node by using the predicted value φ_{predPoint} of the horizontal azimuth, the low-plane horizontal azimuth φ_{left} of the current node, and the high-plane horizontal azimuth φ_{right} of the current node. Details are as follows:

int angLel = φ_{left} − φ_{pred};
int angLeR = φ_{right} − φ_{pred};
int context = (angLel ≥ 0&&angLeR ≥ 0)||(angLel < 0&&angLeR < 0)? 0: 2;
int absAngleL = abs(angLel);
int absAngleR = abs(angLeR);
context+= absAngleL > absAngleR? 0: 1; and
context+= maxAngle > minAngle << 1? 4: 0.

After LaserIdx of a node is decoded, predictive decoding is performed on a Z-axis direction of the current node by using LaserIdx corresponding to the current node. That is, radius information radius of a radar coordinate system is calculated by using x and y information of the current node. Then, a tangent value of the current node and an offset in a vertical direction are obtained by using LaserIdx of the current node. In this case, a predicted value, that is, Z_pred, of the current node in the Z-axis direction may be obtained. Details are as follows:

int radius = \sqrt{(pointPos[0] − LidarOrigin[0])2 + (pointPos[1] − LidarOrigin[1])2;}
int tanTheta= tanθ_{laserIdx};
int zOffset= Z_{laserIdx}:
Z_pred= radius ×tanTheta− zOffset.

Further, Z_res and Z_pred that are obtained through the decoding are used to reconstruct and restore geometric information in the Z-axis direction of the current node.

For geometric information encoding based on a triangle soup (trisoup), geometric partitioning needs to be performed first in a geometric information encoding framework based on a trisoup. However, different from that in geometric information encoding based on a binary tree, a quadtree, or an octree, in this method, a point cloud does not need to be divided into unit cubes with side lengths of 1×1×1, but is divided until a block with a side length of W is obtained. Based on a surface formed by point clouds in each block, a maximum of twelve vertices generated by the surface and twelve edges of the block are obtained. Vertex coordinates of each block are successively encoded to generate a binary bitstream.

When reconstructing geometric information of a point cloud based on a trisoup, a decoding end first decodes vertex coordinates, to reconstruct a triangular patch. This process is shown in FIG. 19A, FIG. 19B, and FIG. 19C. There are three vertices (v1, v2, and v3) in the block shown in FIG. 19A. A triangle soup is formed by the three vertices in a specific order, that is, trisoup, as shown in FIG. 19B. Then, sampling is performed on the triangle soup, and obtained sampling points are used as a reconstructed point cloud in the block, as shown in FIG. 19C.

Predictive geometry coding (PredGeomTree) includes: sorting points of an input point cloud in sequence first, where sorting methods currently used include disordering, Morton ordering, azimuth ordering, and radial distance ordering. At an encoding end, a prediction tree structure is established in two different modes, including KD-tree (a high-latency slow mode) and a low-latency fast mode (by using LiDAR calibration information). When the LiDAR calibration information is used, points are assigned to different lasers, and a prediction tree structure is established according to the different lasers. Next, based on the prediction tree structure, each node in the prediction tree is traversed, geometric position information of the nodes is predicted by selecting different prediction modes, to obtain prediction residuals, and the geometric prediction residuals are quantized by using a quantization parameter. Finally, with continuous iterations, the prediction residuals of position information of the prediction tree nodes, the prediction tree structure, the quantization parameter, and the like are encoded to generate a binary bitstream.

For predictive geometry decoding, a decoding end continuously parses the bitstream to reconstruct a prediction tree structure, obtains prediction residual information of a geometric position of each prediction node and a quantization parameter through the parsing, and inverse quantizes the prediction residual to obtain reconstructed geometric position information of each node and finally completes geometric reconstruction.

After geometry encoding is completed, geometric information needs to be reconstructed. Currently, attribute encoding is mainly performed on color information. First, the color information is converted from an RGB color space to a YUV color space. Then, the point cloud is colored again by using the reconstructed geometric information, so that attribute information that is not encoded corresponds to the reconstructed geometric information. During encoding of the color information, there are mainly two transform methods. One method is distance-based lifting transform based on LOD division, and the other method is to directly perform RAHT. In both methods, the color information is transformed from a spatial domain to a frequency domain, to obtain a high frequency coefficient and a low frequency coefficient. Finally, the coefficients are quantized and encoded to generate a binary bitstream. For details, reference may be made to FIG. 4A and FIG. 4B.

Further, when the attribute information is predicted by using the geometric information, a Morton code is used to perform nearest neighbor search. The Morton code corresponding to each point in the point cloud may be obtained by using geometric coordinates of the point. The following describes a specific method for calculating the Morton code. For three-dimensional coordinates in which each component is represented by a binary number with d bits, the three components may be represented as:

$$x = {\sum }_{ℓ = 1}^{d} {2}^{d - ℓ} {x}_{ℓ} , y = {\sum }_{l = 1}^{d} {2}^{d - ℓ} {y}_{ℓ} , z = {\sum }_{l = 1}^{d} {2}^{d - ℓ} {z}_{ℓ} \qquad ( 16 )$$

Herein [symbol] ∈{0,1} are respectively binary values corresponding to x, y, and z from a highest bit ( [symbol] =1) to a lowest bit ( [symbol] =d). The Morton code M is obtained by arranging [symbol] for x, y, and z in a sequence from the most significant bit to the least significant bit. A calculation formula of M is as follows:

$$M = {\sum }_{ℓ = 1}^{d} {2}^{3 ( d - ℓ )} ( 4 {x}_{ℓ} + 2 {y}_{ℓ} + {z}_{ℓ} ) = {\sum }_{{l}^{′} = 1}^{3 d} {2}^{3 d - {ℓ}^{′}} {m}_{{ℓ}^{′}} \qquad ( 17 )$$

Herein, [symbol] ∈{0,1} denotes values of M from the highest bit ( [symbol] =1) to the lowest bit ( [symbol] =3d). After the Morton code M of each point in the point cloud is obtained, the points in the point cloud are arranged in ascending order of Morton codes, and a weight value w of each point is set to 1.

It may be further understood that, for a G-PCC encoding and decoding framework, common test conditions are as follows.
(1) There are four test conditions.
   Condition 1: A geometric position is limited lossy and an attribute is lossy.
   Condition 2: A geometric position is lossless and an attribute is lossy.
   Condition 3: A geometric position is lossless and an attribute is limited lossy.
   Condition 4: A geometric position is lossless and an attribute is lossless.
(2) A common test sequence includes four types: Cat1A, Cat1B, Cat3-fused, and Cat3-frame. A Cat3-frame point cloud includes only reflectance attribute information, a Cat1A or Cat1B point cloud includes only color attribute information, and a Cat3-fused point cloud includes both color attribute information and reflectance attribute information.
(3) There are two types of technologies, which are distinguished by algorithms used for geometric compression.

### Technology 1: Octree Geometry Encoding

At an encoding end, a bounding box is divided into sub-cubes, and sub-cubes (including points in a point cloud) that are not empty are further divided until leaf nodes obtained through the division are 1×1×1 unit cubes. In a case of lossless geometry encoding, a quantity of points included in each leaf node needs to be encoded, to finally complete octree geometry encoding and generate a binary bitstream.

At a decoding end, parsing is continuously performed in a breadth-first traversal sequence, to obtain an occupancy code of each node, and the nodes are sequentially divided until 1×1×1 unit cubes are obtained. In a case of lossless geometry decoding, parsing needs to be performed to obtain a quantity of points included in each leaf node, to finally restore reconstructed geometric information of a point cloud.

### Technology 2: Predictive Geometry Coding

At an encoding end, a prediction tree structure is established in two different modes: KD-tree (a high-latency slow mode) and LiDAR calibration information (a low-latency fast mode). By using the LiDAR calibration information, the points are assigned to different lasers, and a prediction tree structure is established according to the different lasers. Next, based on the prediction tree structure, each node in the prediction tree is traversed, geometric position information of the nodes is predicted by selecting different prediction modes, to obtain prediction residuals, and the geometric prediction residuals are quantized by using a quantization parameter. Finally, with continuous iterations, the prediction residuals of position information of the prediction tree nodes, the prediction tree structure, the quantization parameter, and the like are encoded to generate a binary bitstream.

At a decoding end, bitstreams are continuously parsed to reconstruct a prediction tree structure, prediction residual information of a geometric position of each prediction node and a quantization parameter are obtained through the parsing, and the prediction residual is inverse quantized to obtain reconstructed geometric position information of each node and finally complete geometric reconstruction.

As mentioned above, the attribute information is encoded in two main transform manners, one is lifting transform, and the other is RAHT. The lifting transform predicts and transforms a point cloud based on a sequence of generating LODs, while the RAHT adaptively transforms the attribute information from bottom to top based on a construction hierarchy of an octree. The RAHT is described in detail below.

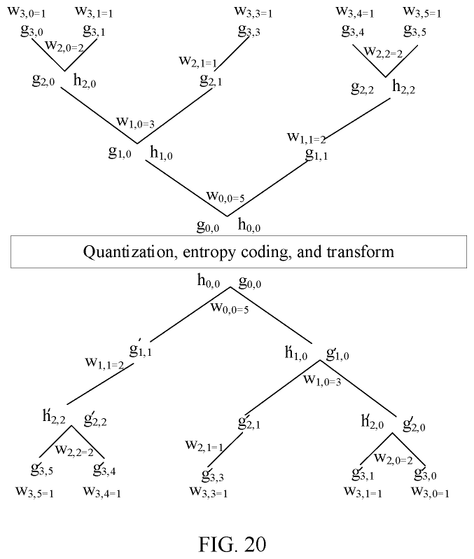

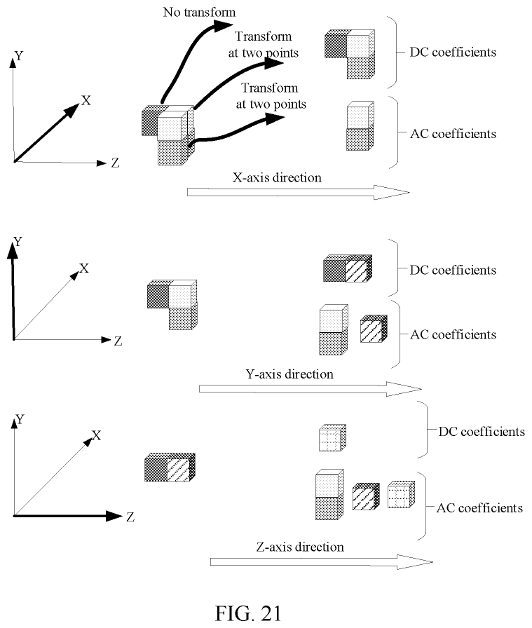

The RAHT adopts Haar wavelet transform, which may transform attribute information of a point cloud from a spatial domain to a frequency domain, thereby further reducing correlation between attribute information of the point cloud. FIG. 20 is an example diagram of a RAHT process. As shown in FIG. 20, the RAHT performs wavelet transform based on a hierarchical structure of an octree, thereby associating attribute information with nodes of the octree. Attribute information of occupied nodes in the same parent node is recursively transformed in a bottom-up manner, and for nodes in each layer, transform is performed in three dimensions of x, y, and z respectively (see FIG. 21), until the transform reaches a root node of the octree. In the process of hierarchical transform, a direct current (DC) coefficient (or called low-pass coefficient) obtained by performing transform on nodes in the same layer is transferred to nodes in an upper layer to continue the transform, and all alternating current (AC) coefficients (or called high-pass coefficients) are quantized and encoded.

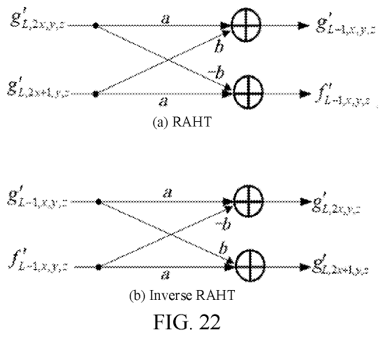

FIG. 22 is a schematic diagram of RAHT and inverse RAHT. It is assumed that

$${g}_{L2xyz}^{′} and {g}_{L , 2 x + 1 , y , z}^{′}$$

are two DC coefficients that are neighboring points of each other in layer L. After RAHT, information of layer L−1 is an AC coefficient

$${f}_{L - 1 xyz}^{′}$$

and a DC coefficient

$${g}_{L - 1 \times yz}^{′} . \qquad {f}_{L - 1 xyz}^{′}$$

will no longer be transformed, and is directly quantized and encoded, while for

$${g}_{L - 1 , x , y , z}^{′} ,$$

a neighboring point will continue to be searched for transform. If no neighboring point is found,

$${g}_{L - 1 , x , y , z}^{′}$$

may be transferred directly to a layer L−2. That is to say, RAHT is only effective for a node with a neighboring point, and a node without a neighboring point will be directly transferred to an upper layer. In the foregoing transform process, weights corresponding to

$${g}_{L , 2 x , y , z}^{′} and {g}_{L , 2 x + 2 , y , z}^{′}$$

(the weights may be determined based on a quantity of non-empty subnodes in the node) are

$${w}_{L , 2 x , y , {z}^{′}}^{′} and {w}_{L , 2 x + 1 , y , z}^{′} ( {w}_{0}^{′} and {w}_{1}^{′} for short )$$

respectively, a weight of

$${g}_{L - 1 , x , y , z}^{′} is {w}_{L - 1 , x , y , z}^{′} ,$$

and then a general transform formula of RAHT is as follows:

$$[ \begin{matrix}{g}_{L - 1 , x , y , z}^{′} \\ {f}_{L - 1 , x , y , z}^{′}\end{matrix} ] = {T}_{w 0 w 1} [ \begin{matrix}{g}_{L , 2 x , y , z}^{′} \\ {g}_{L , 2 x + 1 , y , z}^{′}\end{matrix} ] \qquad ( 18 )$$

In formula (18), T_{w0w1} is a transform matrix, and the transform matrix may be determined based on formula (19):

$${T}_{w 0 w 1} = \frac{1}{\sqrt{{w}_{0}^{′} + {w}_{1}^{′}}} [ \begin{matrix}\sqrt{{w}_{0}^{′}} & \sqrt{{w}_{1}^{′}} \\ - \sqrt{{w}_{1}^{′}} & \sqrt{{w}_{0}^{′}}\end{matrix} ] \qquad ( 19 )$$

The transform matrix is adaptively updated with transform of weights corresponding to respective points. The foregoing transform process is continuously iteratively updated according to a partitioning structure of an octree until a root node of the octree is processed.

On the basis of RAHT, RAHT intra prediction may be performed on attribute information, that is, RAHT intra prediction combined with transform encoding may be performed on the attribute information. This encoding mode is described in detail below.

As shown in FIG. 20, RAHT is performed, based on a hierarchical sequence of an octree, continuously from a voxel level until a root node is obtained, thereby completing hierarchical transform encoding of entire attribute information. In the RAHT intra prediction combined with transform encoding, prediction combined with transform encoding may also be performed on the attribute information based on the hierarchical sequence of the octree. A difference lies in that a process of the RAHT intra prediction combined with transform encoding may be continuously performed from the root node to the voxel level. In each RAHT process, prediction and transform encoding may be performed on the attribute information based on a 2×2×2 block.

For a structure of an encoding block of the attribute information, reference may be made to FIG. 23. The dark gray block in FIG. 23 is a current block to be encoded, and the light gray blocks are neighboring blocks that are coplanar and co-edge with the current block. Attribute information of the current block may be normalized based on formula (20) to formula (20)

$${A}_{node} = {\sum }_{p ∈ node} attribute ( p ) \qquad ( 20 )$$

$${w}_{node} = {\sum }_{p ∈ node} 1 = \# \{ p ∈ node \} \qquad ( 21 )$$

$${a}_{node} = {A}_{node} / {w}_{node} \qquad ( 22 )$$

Specifically, first, the attribute information of the current block may be obtained based on attribute information of a node in the current block, that is, A_{node}. For example, a simple summation operation may be performed on the attribute information of the node in the current block to determine A_{node}. Then, normalization processing may be performed by using the attribute information of the current block and a quantity (that is, w_{node}) of nodes in the current block to obtain a mean value a_{node} of the attribute information of the current block. Next, transform encoding may be performed by using the mean value of the attribute information of the current block.

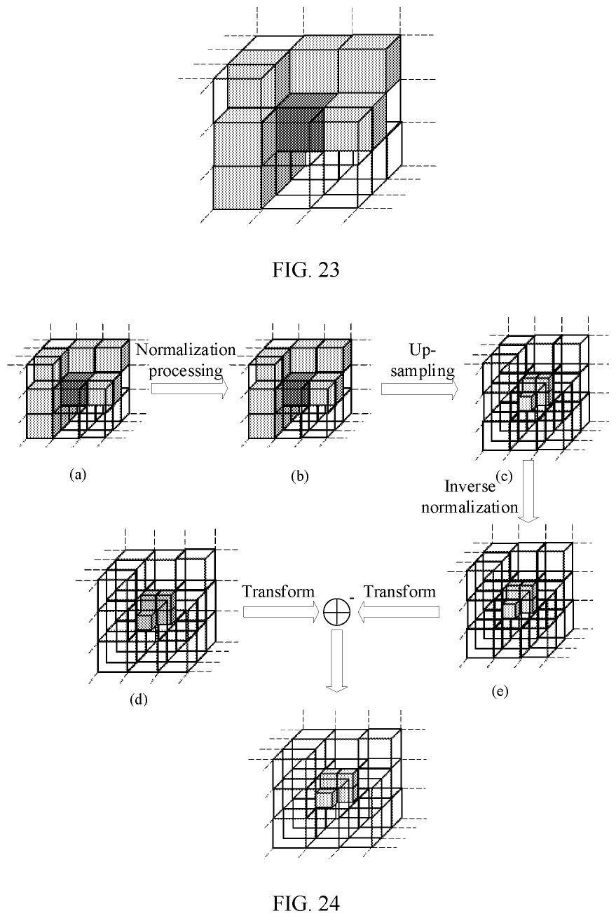

FIG. 24 shows an overall flow of RAHT intra prediction combined with transform encoding for attribute information. Part (d) in FIG. 24 represents attribute information of a current block, and part (e) in FIG. 24 represents attribute information of a prediction block obtained by performing linear weighted fitting by using neighboring attribute information of the current block. Then, attribute transform may be performed on each of the attribute information of the current block and the attribute information of the prediction block to obtain DC coefficients and AC coefficients. Then, predictive encoding may be performed on the AC coefficients.

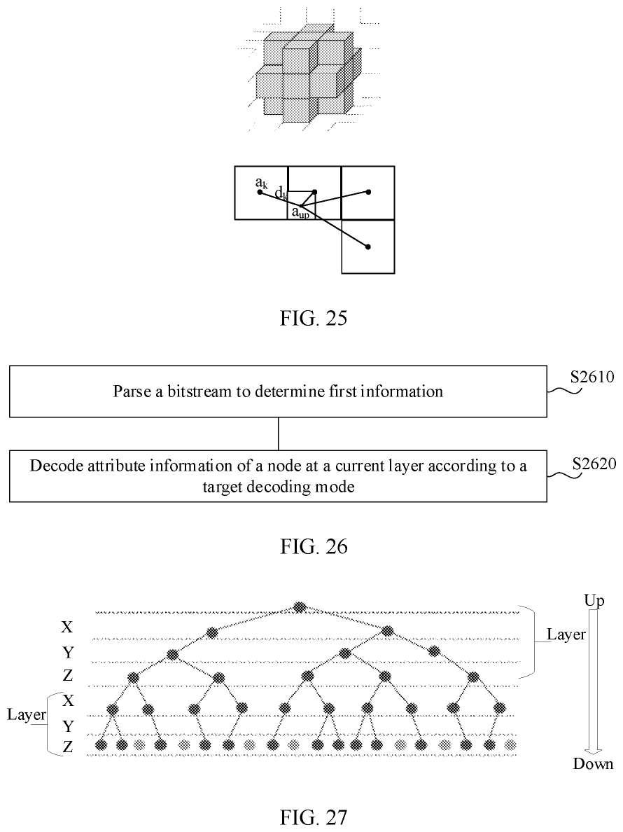

FIG. 25 is an example diagram of a linear fitting method for neighboring attribute information of a current block. As shown in FIG. 25, first, 19 neighboring blocks of a current block may be first determined. Second, linear weighted prediction is performed on attribute information of each subblock by using spatial geometric distances between the neighboring blocks and each subblock in the current block, to obtain attribute information of a prediction block. Then, the attribute information of the prediction block may be transformed. For example, formula (23) to formula (25) may be used for prediction and transform of the attribute information (formula (23) represents a transform manner of the attribute information of the current block, formula (24) represents a transform manner of the attribute information of the prediction block, and formula (25) outputs predicted residual information):

$$[ \begin{matrix}* \\ {}_{orig} {AC}_{1} \\ ⋮ \\ {AC}_{k - 1 ig}\end{matrix} ] = {T}_{node} [ \begin{matrix}{A}_{1} , orig / \sqrt{{w}_{1}} \\ ⋮ \\ {A}_{k , orig} / \sqrt{{w}_{k}}\end{matrix} ] \qquad ( 23 )$$

$$[ \begin{matrix}* \\ {}_{up} {AC}_{1} \\ ⋮ \\ {AC}_{k - 1 p}\end{matrix} ] = {T}_{node} [ \begin{matrix}{A}_{1 , up} / \sqrt{{w}_{1}} \\ ⋮ \\ {A}_{k , up} / \sqrt{{w}_{k}}\end{matrix} ] \qquad ( 24 )$$

$$[ \begin{matrix}{}_{\text{?}} {DC}_{h d - 1} \\ {AC}_{{1}^{, res}} \\ ⋮ \\ {AC}_{k - 1 , res}\end{matrix} ] = [ \begin{matrix}{}_{\text{?}} {DC}_{th d - 1} \\ {AC}_{1 , orig} \\ ⋮ \\ {AC}_{k - 1 , orig}\end{matrix} ] - [ \begin{matrix}0 \\ {AC}_{1 , up} \\ ⋮ \\ {AC}_{k - 1 p}\end{matrix} ] \qquad ( 25 )$$

$$\text{?} \text{indicates text missing or illegible when filed}$$

The RAHT intra prediction combined with transform encoding is described in detail above. In some implementations, RAHT inter prediction combined with transform encoding may further be enabled, and the RAHT inter prediction combined with transform encoding is used in combination with the RAHT intra prediction combined with transform encoding. This encoding mode is described in detail below.

If inter prediction encoding is enabled, first, a RAHT attribute transform encoding structure is constructed based on geometric information of a current node, that is, node merging is continuously performed from a voxel level until a root node of an entire RAHT tree is obtained, thereby obtaining a transform encoding hierarchical structure corresponding to the attribute information. Next, according to the RAHT structure, partition is performed from the root node to obtain N child nodes of each node (N is less than or equal to 8). Different from the encoding mode of the RAHT intra prediction combined with transform, an encoding mode of the RAHT inter prediction combined with transform uses node information of a reference frame. For example, RAHT may be performed on attribute information of the N child nodes of the current node to obtain DC and AC coefficients. Then inter prediction may be performed on the AC coefficients of the N child nodes in the following manner.

For example, if an inter prediction node of the current node is valid (that is, a co-located node of the current node in the reference frame exists), attribute information of the prediction node is directly used as an attribute predicted value of the current node.

For another example, for the current node, if a node with exactly the same position as the current node may be found in a buffer of the reference frame (that is, a co-located node of the current node in the reference frame exists), attribute predicted values of the AC coefficients of the N child nodes of the current node may be determined based on AC coefficients of M child nodes included in the co-located node. For example, if an AC coefficient of an inter prediction node corresponding to a specific child node is not zero, the AC coefficient of the inter prediction node is directly used as a predicted value of the child node; if an AC coefficient of an inter prediction node corresponding to a specific child node is zero, an AC coefficient of an intra prediction node corresponding to the child node may be used as a predicted value.

For another example, if an inter prediction node of the current node is invalid (that is, no co-located node of the current node in the reference frame exists), an attribute predicted value of an intra neighboring node may be used as the attribute predicted value of the current node.

In addition, after RAHT inter prediction is enabled, for each layer, an optimal RAHT prediction mode may be selected. The RAHT prediction mode may be a RAHT intra prediction mode or a RAHT inter prediction mode. If the cost of the RAHT intra prediction mode is less than the cost of the RAHT inter prediction mode, the RAHT intra prediction may be performed on a current layer; otherwise the RAHT inter prediction is performed.

In a related technology, if RAHT inter prediction is enabled, an optimal RAHT prediction mode is selected from a RAHT inter prediction mode and a RAHT intra prediction mode. However, in some cases, prediction performance of both the RAHT inter prediction and RAHT intra prediction is relatively poor. In this case, if the solution provided in the related technology is adopted, encoding and decoding performance of attribute information will be poor.

In view of the foregoing problem, an embodiment of this application provides an encoding method, and the method includes: determining a target encoding mode corresponding to a current layer from a plurality of encoding modes, where the plurality of encoding modes include RAHT encoding and RAHT prediction combined with transform encoding; and encoding attribute information of a node at the current layer according to the target encoding mode.

An embodiment of this application further provides a decoding method, and the method includes: parsing a bitstream to determine first information, where the first information is used to indicate a target decoding mode from a plurality of decoding modes corresponding to a current layer, and the plurality of decoding modes include RAHT decoding and RAHT prediction combined with transform decoding; and decoding attribute information of a node at the current layer according to the target decoding mode.

In a related technology, after RAHT prediction combined with transform encoding is enabled, RAHT prediction needs to be performed based on RAHT. An RAHT prediction process is relatively complex. If performance of RAHT prediction is poor, and the RAHT prediction is forcibly performed, no significant improvement is made to encoding efficiency of attribute information of a point cloud. In this case, existence of the RAHT prediction process will more likely lead to an increase in encoding complexity and additionally introduce more encoding loss. In view of the foregoing problems, an embodiment of this application propose to select an encoding mode between RAHT prediction combined with transform encoding and RAHT encoding. That is to say, in embodiments of this application, even if the RAHT prediction combined with transform encoding is enabled, it is possible to return to the RAHT encoding, so that when performance of the RAHT prediction is poor, a solution with relatively low encoding complexity and relatively small encoding loss can be selected, so that the encoding performance can be optimized.

The decoding method provided in embodiments of this application will be described in detail below with reference to the accompanying drawings.

FIG. 26 is a schematic flowchart of a decoding method according to an embodiment of this application. The decoding method illustrated in FIG. 26 may be applied to a decoder. The decoding method in FIG. 26 may be used to decode attribute information of a point cloud. In some implementations, the decoding method may be applied to G-PCC. Alternatively, in some other implementations, the decoding method may be applied to a geometry explore solid test model (GES-TM). The GES-TM is an encoding and decoding framework proposed for dense point clouds (such as point clouds collected in an augmented reality (AR) or virtual reality (VR) scenario).

Referring to FIG. 26, in step S2610, a bitstream is parsed to determine first information.

The first information is used to indicate a target decoding mode from a plurality of decoding modes corresponding to a current layer.

The first information may be carried at any location in the bitstream. For example, the first information may be carried in an attribute brick header (ABH).

The first information may correspond to a RAHT layer, that is, the first information may be information of the RAHT layer.

The current layer may also be referred to as a RAHT layer, a RAHT decoding layer, a RAHT attribute decoding layer, or a RAHT transform layer. The current layer may be determined based on partition (or downsampling) performed on a previous layer of the current layer at least once in each of an X direction, a Y direction, and a Z direction. For example, a RAHT decoding order is usually to perform partition sequentially from a root node to a voxel level (1×1×1), thereby completing decoding and attribute reconstruction of attribute information of an entire point cloud. Therefore, referring to FIG. 27, a layer obtained by performing one partition or downsampling along the X direction, Y direction, and Z direction each time may be defined as one RAHT layer.

The target decoding mode indicated by the first information may be referred to as an optimal decoding mode of the current layer. The target decoding mode may be determined based on rate distortion costs of the plurality of decoding modes. For example, the target decoding mode may be a decoding mode with the smallest rate distortion cost in the plurality of decoding modes. For a calculation manner of the rate distortion cost, reference may be made to description on the encoding side. Details are not described herein.

The foregoing plurality of decoding modes may include RAHT decoding and RAHT prediction combined with transform decoding. In other words, in embodiments of this application, decoding performance of the RATH prediction combined with transform decoding and decoding performance of the RAHT decoding are both considered. In a case that performance of RATH prediction is poor, introduction of the RAHT decoding helps to improve decoding performance of attribute information.

A decoding manner of the RAHT prediction combined with transform decoding is not specifically limited in embodiments of this application. For example, the RAHT prediction combination transform decoding may include at least one of the following: RAHT intra prediction combined with transform decoding; RAHT inter prediction combined with transform decoding; or a combination of RAHT intra prediction combined with transform decoding and RAHT inter prediction combined with transform decoding (for example, if a co-located node of a node to be decoded exists in a reference frame, the RAHT inter prediction combined with transform is performed; if no co-located node exists, the RAHT intra prediction combined with transform decoding is performed).

In some implementations, the RAHT prediction combined with transform decoding includes the RAHT inter prediction combined with transform decoding, and a reference frame of the RAHT inter prediction combined with transform decoding is a reference frame that has undergone global motion compensation or local motion compensation.

In some implementations, the various decoding modes mentioned above may include RAHT decoding, the RAHT intra prediction combined with transform decoding, and the combination of the RAHT intra prediction combined with transform decoding and the RAHT inter prediction combined with transform decoding. In other words, an optimal decoding mode may be selected from the RAHT intra prediction combined with transform decoding and the combination of the RAHT intra prediction combined with transform decoding and the RAHT inter prediction combined with transform decoding. In a case that decoding performance of the RAHT prediction combined with transform decoding is poor, the RAHT decoding is further considered (that is, no prediction is performed, only RAHT is performed), which helps to improve decoding performance of attribute information.

In some implementations, the foregoing plurality of decoding modes may include RAHT decoding, the RAHT intra prediction combined with transform decoding, and the RAHT inter prediction combined with transform decoding. In other words, an optimal decoding mode may be selected from the RAHT decoding, the RAHT intra prediction combined with transform decoding, and the RAHT inter prediction combined with transform decoding. In a case that decoding performance of the RAHT prediction combined with transform decoding is poor, the RAHT decoding is further considered (that is, no prediction is performed, only RAHT is performed), which helps to improve decoding performance of attribute information.

In some implementations, whether to execute step S2610 may be determined based on some conditions. For example, first, it may be determined whether attribute information of a node in the current layer meets a condition for performing inter prediction. If the attribute information meets the condition for performing inter prediction, step S2610 is performed. Otherwise, step S2610 may not be performed. The condition for performing inter prediction may be, for example, whether a current frame is a P frame or a B frame.

In some implementations, whether attribute prediction decoding can be used at the current layer may be first determined before it is determined whether the attribute information of the node in the current layer meets the condition for performing inter prediction. For example, it may be determined, based on a quantity of neighboring nodes at the current layer and/or a quantity of neighboring nodes at a parent node of the node in the current layer, whether attribute prediction decoding can be used at the current layer. For example, if the quantity of neighboring nodes at the current layer is greater than or equal to a first threshold and/or the quantity of neighboring nodes of the parent node of the node in the current layer is greater than or equal to a second threshold, it is determined that the attribute prediction decoding can be used at the current layer.

In some implementations, if the attribute information of the node in the current layer does not meet the condition for performing inter prediction, at least one of RAHT decoding or RAHT intra prediction combined with transform decoding is performed on the attribute information.

Still referring to FIG. 26, in step S2620, the attribute information of the node in the current layer is decoded according to the target decoding mode. For example, the bitstream may be first parsed to determine a quantized coefficient of the node in the current layer. Then, inverse quantization may be performed on the quantized coefficient obtain an AC coefficient of the node in the current layer. Next, prediction and/or inverse transform may be performed on the AC coefficient according to the target decoding mode, to determine reconstructed attribute information of the node in the current layer.

In some implementations, if the target decoding mode is the combination of the RAHT intra prediction combined with transform decoding and the RAHT inter prediction combined with transform decoding, step S2620 may include determining whether an inter predicted value of the AC coefficient of the node in the current layer is equal to zero. If the inter predicted value is not equal to zero, it may be determined that the predicted value of the AC coefficient is the inter predicted value; if the inter predicted value is equal to zero, it may be determined that the predicted value of the AC coefficient of the node in the current layer is an intra predicted value.

In some implementations, if the target decoding mode is the combination of the RAHT intra prediction combined with transform decoding and the RAHT inter prediction combined with transform decoding, step S2620 may include: determining an intra predicted value and an inter predicted value of an AC coefficient of the node at the current layer based on the target decoding mode; fusing the intra predicted value and the inter predicted value to determine a target predicted value of the AC coefficient; and determining reconstructed attribute information of the node at the current layer based on the target predicted value. Fusing an intra predicted result and an inter predicted result helps to improve accuracy of prediction information, thereby improving decoding performance of the attribute information.

For example, an arithmetic average value of the intra predicted value and the inter predicted value may be used as the target predicted value.

For another example, weighted summation may be performed on the intra predicted value and the inter predicted value to determine the target predicted value. Assuming that the intra predicted value of an AC coefficient of a current node (which may be any node at the current layer) is predIntraVal, and the inter predicted value is predInterVal, the target predicted value predVal may be calculated by using formula (26):

$$predVal = w 1 * predIntraVal + W 2 * predIntraVal \qquad ( 26 )$$

where w1 and w2 respectively represent weights of predIntraVal and predIntraVal.

The weights of the intra predicted value and the inter predicted value of the AC coefficient of the current node may be determined in a plurality of manners. This is not specifically limited in embodiments of this application. For example, the weights of the intra predicted value and the inter predicted value may be determined based on a quantity of neighboring nodes during intra prediction. A larger quantity of neighboring nodes during intra prediction indicates a higher weight of the intra predicted value. Alternatively, a plurality of weights may be predefined for the intra predicted value and the inter predicted value, and then optimal weights are determined based on a rate-distortion optimization algorithm.

As mentioned above, in some implementations, the plurality of decoding modes may include the RAHT inter prediction combined with transform decoding. A reference frame of the RAHT inter prediction combined with transform decoding may be a reference frame that has not undergone motion compensation, or may be a reference frame that has undergone motion compensation. Further, in some implementations, a first reference frame and a second reference frame may be both introduced for the RAHT inter prediction combined with transform decoding. The first reference frame is a reference frame that has undergone motion compensation (which may refer to local motion compensation or global motion compensation), and the second reference frame is a reference frame that has not undergone motion compensation (which may refer to local motion compensation or global motion compensation). At the encoding end, inter prediction may be performed based on the first reference frame and the second reference frame, and an appropriate reference frame may be selected based on rate distortion costs. Then, second information may be written into the bitstream to indicate the reference frame corresponding to the RAHT inter prediction combined with transform decoding. On the decoding side, the bitstream may be parsed to determine the reference frame corresponding to the RAHT inter prediction combined with transform decoding. Both the reference frame that has undergone motion compensation and the reference frame that has not undergone motion compensation are considered, which helps to improve encoding and decoding performance.

In some implementations, the bitstream may be parsed to determine third information. The third information is used to indicate whether the reference frame that has undergone motion compensation is used for RAHT inter prediction. For example, the third information may include a first value (such as 1 or true) and a second value (such as 0 or false). If a value of the third information is the first value, it indicates that the reference frame that has undergone motion compensation may be used for the RAHT inter prediction. If a value of the third information is the second value, it indicates that only a reference frame that has not undergone motion compensation is used for the RAHT inter prediction.

The foregoing third information may correspond to a slice (slice, also referred to as a strip). In other words, the third information may be slice-level information, and is used to indicate whether a slice can use a reference frame that has undergone motion compensation for the RAHT inter prediction.

Alternatively, the foregoing third information may correspond to a RAHT layer. In other words, the third information may be information of a RAHT layer, and is used to indicate whether a RAHT layer can use a reference frame that has undergone motion compensation for the RAHT inter prediction.

The foregoing plurality of encoding modes are set to the following three encoding modes: RAHT decoding, RAHT intra prediction combined with transform decoding, and a combination of the RAHT intra prediction combined with transform decoding and RAHT inter prediction combined with transform decoding. Table 1 and Table 2 show test results of the solution provided in embodiments of this application (the comparison object is an RAHT inter prediction solution provided by a related technology).

TABLE 1
Encoding performance test results under geometric
lossless and attribute lossy condition

| C1 (geometric lossless and | | | | |
|---|---|---|---|---|
| attribute lossy condition) | | | | |
| Class | Sequence | Luma | Chroma Cb | Chroma Cr |
| zzz | 8ivfbv2_soldier_vox10 | −6.7% | 1.8% | 2.2% |
| | queen | −1.6% | 0.7% | 0.7% |

TABLE 2
Encoding performance test results under geometric
lossy and attribute lossy condition

| C2 (geometric lossy or | | | | |
|---|---|---|---|---|
| attribute lossy condition) | | | | |
| Class | Sequence | Luma | Chroma Cb | Chroma Cr |
| zzz | 8ivfbv2_soldier_vox10 | −12.3% | −7.3% | −7.4% |
| | queen | −11.0% | −10.0% | −10.6% |

In Table 1 and Table 2, Luma represents luminance, Cb and Cr represent chrominance. From the test results shown in Table 1 and Table 2, it can be seen that if the test condition is C1, compared with the RAHT inter prediction solution provided by the related technology, a performance gain in the solution provided in embodiments of this application is 6.7% on the video sequence 8ivfbv2_soldier_vox10; if the test condition is C2, compared with the RAHT inter prediction solution provided by the related technology, the performance gain in the solution provided in embodiments of this application can reach 12.3% on the video sequence 8ivfbv2_soldier_vox10. The reason for achieving the above performance gain is precisely that when RAHT prediction performance is poor, it is possible to return to the RAHT encoding mode through a rate-distortion optimization algorithm, thereby optimizing the encoding performance as a whole.

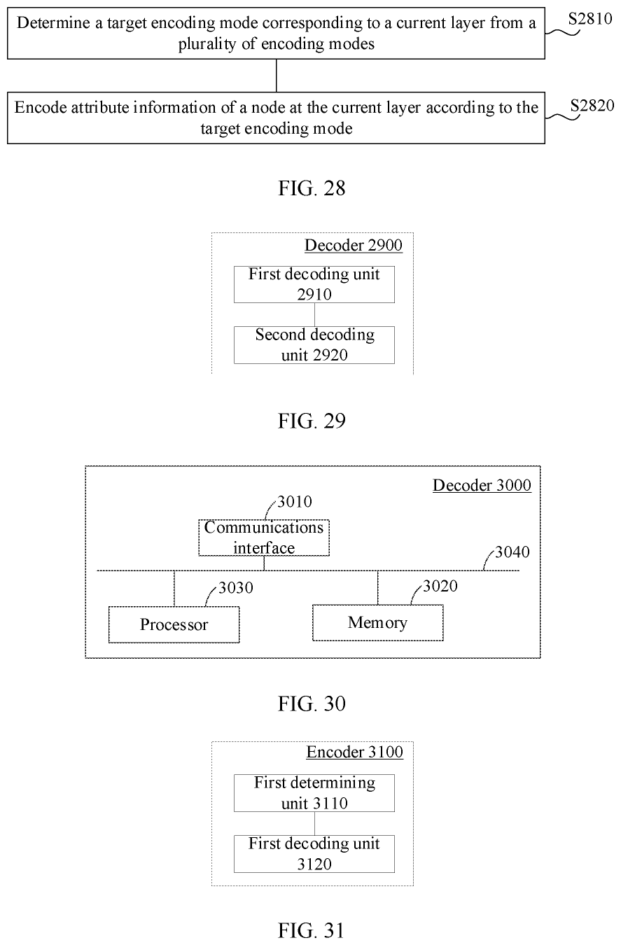

The decoding method provided in embodiments of this application is described in detail above with reference to FIG. 26. An encoding method provided in embodiments of this application is described in detail below with reference to FIG. 28.

FIG. 28 is a schematic flowchart of an encoding method according to an embodiment of this application. The encoding method illustrated in FIG. 28 may be applied to an encoder. The encoding method illustrated in FIG. 28 may be used to encode attribute information of a point cloud. In some implementations, the encoding method may be applied to G-PCC. Alternatively, in some other implementations, the encoding method may be applied to GES-TM. GES-TM is an encoding framework proposed for dense point clouds (such as point clouds collected in an AR or VR scenario).

Referring to FIG. 28, in step S2810, a target encoding mode corresponding to a current layer is determined from a plurality of encoding modes.

The current layer may also be referred to as a RAHT layer, a RAHT encoding layer, a RAHT attribute encoding layer, or a RAHT transform layer. The current layer may be determined based on partition (or downsampling) performed on a previous layer of the current layer at least once in each of an X direction, a Y direction, and a Z direction. For example, a RAHT encoding sequence is usually to perform partition sequentially from a root node to a voxel level (1×1×1), thereby completing encoding and attribute reconstruction of attribute information of an entire point cloud. Therefore, referring to FIG. 27, a layer obtained by performing one partition or downsampling along the X direction, Y direction, and Z direction each time may be defined as one RAHT layer.

The target encoding mode may be referred to as an optimal encoding mode at the current layer. The target encoding mode may be determined based on rate distortion costs of the plurality of encoding modes. For example, the target encoding mode may be an encoding mode with the smallest rate distortion cost in the plurality of decoding modes.

The rate distortion costs of the plurality of encoding modes may be determined based on distortion parameters, bit rate parameters, and Lagrange multipliers that correspond to the plurality of encoding modes. For example, for each encoding mode, a distortion parameter may be determined based on reconstructed attribute information and original attribute information of each encoding mode. Then, a quantity of encoding bits required for each encoding mode may be determined, thereby determining a bit rate parameter. Next, a rate distortion cost of each encoding mode may be determined based on the following formula (27):

$$J = D + λ \times R \qquad ( 27 )$$

Herein J represents a rate distortion cost, D represents a distortion parameter, R represents a bit rate parameter, and s′ represents a Lagrange multiplier.

The Lagrange multiplier may be determined based on a quantization parameter of attribute information of a node at the current layer. For example, a value of λ may be determined based on the following formula (28):

$$λ = {2}^{\frac{QP - 4}{6}} \times N \qquad ( 28 )$$

Herein QP represents the quantization parameter of the attribute information. N may be a predefined value. A value of N may be associated with a type of the attribute information. For example, there may be different values of N for reflectance and color information.

The foregoing plurality of encoding modes may include RAHT encoding and RAHT prediction combined with transform encoding. In other words, in embodiments of this application, when RATH prediction combined with transform encoding is enabled, not only the RATH prediction combined with transform encoding is considered, RATH prediction combined with transform encoding and RAHT encoding are both considered. This helps improve encoding performance of attribute information.

An encoding manner of RAHT prediction combined with transform encoding is not specifically limited in embodiments of this application. For example, the RAHT prediction combined with transform encoding may include at least one of the following: RAHT intra prediction combined with transform encoding; RAHT inter prediction combined with transform encoding; or a combination of RAHT intra prediction combined with transform encoding and RAHT inter prediction combined with transform encoding (for example, if a co-located node of a node to be encoded exists in a reference frame, the RAHT inter prediction combined with transform is performed; if no co-located node exists, the RAHT intra prediction combined with transform encoding is performed).

In some implementations, the RAHT prediction combined with transform encoding includes the RAHT inter prediction combined with transform encoding, and a reference frame of the RAHT inter prediction combined with transform encoding is a reference frame that has undergone global motion compensation or local motion compensation.

In some implementations, the various encoding modes mentioned above may include RAHT encoding, the RAHT intra prediction combined with transform encoding, and the combination of the RAHT intra prediction combined with transform encoding and the RAHT inter prediction combined with transform encoding. In other words, an optimal encoding mode may be selected from the RAHT encoding, the RAHT intra prediction combined with transform encoding, and the combination of the RAHT intra prediction combined with transform encoding and the RAHT inter prediction combined with transform encoding. In a case that encoding performance of the RAHT prediction combined with transform encoding is poor, the RAHT encoding is further considered (that is, no prediction is performed, only RAHT is performed), which helps to improve encoding performance of attribute information.

In some implementations, the foregoing plurality of encoding modes may include RAHT encoding, the RAHT intra prediction combined with transform encoding, and the RAHT inter prediction combined with transform encoding. In other words, an optimal encoding mode may be selected from the RAHT encoding, the RAHT intra prediction combined with transform encoding, and the RAHT inter prediction combined with transform encoding. In a case that encoding performance of the RAHT prediction combined with transform encoding is poor, the RAHT encoding is further considered (that is, no prediction is performed, only RAHT is performed), which helps to improve encoding performance of attribute information.

In some implementations, whether to execute step S2810 may be determined based on some conditions. For example, first, it may be determined whether attribute information of a node in the current layer meets a condition for performing inter prediction. If the attribute information meets the condition for performing inter prediction, step S2810 is performed. Otherwise, step S2810 may not be performed. The condition for performing inter prediction may be, for example, whether a current frame is a P frame or a B frame. In other words, when the RAHT inter prediction is performed on the attribute information, if RAHT attribute inter prediction can be performed on the current layer, a plurality of encoding modes may be introduced to the current layer, and then an optimal encoding mode is selected (for example, by using a rate-distortion optimization algorithm) from the plurality of encoding modes for encoding, so that encoding efficiency of attribute information of the point cloud may be improved.

In some implementations, whether attribute prediction encoding can be used at the current layer may be first determined before it is determined whether the attribute information of the node in the current layer meets the condition for performing inter prediction. For example, it may be determined, based on a quantity of neighboring nodes at the current layer and/or a quantity of neighboring nodes at a parent node of the node in the current layer, whether attribute prediction encoding can be used at the current layer. For example, if the quantity of neighboring nodes at the current layer is greater than or equal to a first threshold and/or the quantity of neighboring nodes of the parent node of the node in the current layer is greater than or equal to a second threshold, it is determined that the attribute prediction encoding can be used at the current layer.

In some implementations, if the attribute information of the node in the current layer does not meet the condition for performing inter prediction, at least one of RAHT encoding or RAHT intra prediction combined with transform encoding is performed on the attribute information.

Still referring to FIG. 28, in step S2820, the attribute information of the node in the current layer is encoded according to the target encoding mode. For example, the attribute information of the node at the current layer may be encoded according to the target encoding mode to determine an AC coefficient. Then, a quantized coefficient may be determined based on the AC coefficient; and an encoded bit corresponding to the attribute information is determined based on the quantized coefficient.

In some implementations, the method in FIG. 28 may further include: writing first information into a bitstream. The first information is used to indicate a target encoding mode. In other words, an encoder may transfer an optimal encoding mode (for example, an encoding mode with the lowest rate distortion cost) of the current layer to a decoding end by using the first information. The decoding end may determine the optimal decoding mode by parsing the first information, so as to perform reconstruction and restoration on attribute information of the node at the current layer.

The first information may be carried at any location in the bitstream. For example, the first information may be carried in an attribute brick header.

The first information may correspond to a RAHT layer, that is, the first information may be information of the RAHT layer.

In some implementations, if the target encoding mode is the combination of the RAHT intra prediction combined with transform encoding and the RAHT inter prediction combined with transform encoding, step S2820 may include: determining whether an inter predicted value of the AC coefficient of the node in the current layer is equal to zero. If the inter predicted value is not equal to zero, it may be determined that the predicted value of the AC coefficient is the inter predicted value; if the inter predicted value is equal to zero, it may be determined that the predicted value of the AC coefficient of the node in the current layer is an intra predicted value.

In some implementations, if the target encoding mode is the combination of the RAHT intra prediction combined with transform encoding and the RAHT inter prediction combined with transform encoding, step S2820 may include: determining an intra predicted value and an inter predicted value of an AC coefficient of the node at the current layer based on the target encoding mode; fusing the intra predicted value and the inter predicted value to determine a target predicted value of the AC coefficient; and determining reconstructed attribute information of the node at the current layer based on the target predicted value. Fusing an intra predicted result and an inter predicted result helps to improve accuracy of prediction information, thereby improving encoding performance of the attribute information.

For example, an arithmetic average value of the intra predicted value and the inter predicted value may be used as the target predicted value.

For another example, weighted summation may be performed on the intra predicted value and the inter predicted value to determine the target predicted value. Assuming that the intra predicted value of an AC coefficient of a current node (which may be any node at the current layer) is predIntraVal, and the inter predicted value is predInterVal, then the target predicted value predVal may be calculated by using formula (29):

$$predVal = w 1 * predIntraVal + W 2 * predIntraVal \qquad ( 29 )$$

where w1 and w2 respectively represent weights of predIntraVal and predIntraVal.

The weights of the intra predicted value and the inter predicted value of the AC coefficient of the current node may be determined in a plurality of manners. This is not specifically limited in embodiments of this application. For example, the weights of the intra predicted value and the inter predicted value may be determined based on a quantity of neighboring nodes during intra prediction. A larger quantity of neighboring nodes during intra prediction indicates a higher weight of the intra predicted value. Alternatively, a plurality of weights may be predefined for the intra predicted value and the inter predicted value, and then optimal weights are determined based on a rate-distortion optimization algorithm. Further, index information corresponding to the optimal weights may be transmitted to the decoding end.

As mentioned above, in some implementations, the plurality of encoding modes may include the RAHT inter prediction combined with transform encoding. A reference frame of the RAHT inter prediction combined with transform encoding may be a reference frame that has not undergone motion compensation, or may be a reference frame that has undergone motion compensation. Further, in some implementations, a first reference frame and a second reference frame may be both introduced for the RAHT inter prediction combined with transform encoding. The first reference frame is a reference frame that has undergone motion compensation (which may refer to local motion compensation or global motion compensation), and the second reference frame is a reference frame that has not undergone motion compensation (which may refer to local motion compensation or global motion compensation). At the encoding end, inter prediction may be performed based on the first reference frame and the second reference frame, and an appropriate reference frame may be selected based on rate distortion costs. Then, second information may be written into the bitstream to indicate the reference frame corresponding to the RAHT inter prediction combined with transform encoding. On the decoding side, the bitstream may be parsed to determine the reference frame corresponding to the RAHT inter prediction combined with transform decoding. Both the reference frame that has undergone motion compensation and the reference frame that has not undergone motion compensation are considered, which helps to improve encoding performance. The foregoing RAHT inter prediction combined with transform encoding may be a slice-level encoding mode. In other words, if the foregoing RAHT inter prediction combined with transform encoding is introduced to a slice, attribute information of the slice may be encoded by using the RAHT inter prediction combined with transform encoding.

In some implementations, third information may be written into the bitstream. The third information is used to indicate whether the reference frame that has undergone motion compensation is used for RAHT inter prediction. For example, the third information may include a first value (such as 1 or true) and a second value (such as 0 or false). If a value of the third information is the first value, it indicates that the reference frame that has undergone motion compensation may be used for the RAHT inter prediction. If a value of the third information is the second value, it indicates that only a reference frame that has not undergone motion compensation is used for the RAHT inter prediction.

The foregoing third information may correspond to a slice (also referred to as a strip). In other words, the third information may be slice-level information, and is used to indicate whether a slice can use the reference frame that has undergone motion compensation for the RAHT inter prediction.

Alternatively, the foregoing third information may correspond to a RAHT layer. In other words, the third information may be information of a RAHT layer, and is used to indicate whether a RAHT layer can use the reference frame that has undergone motion compensation for the RAHT inter prediction.

The following describes embodiments of this application in more detail with reference to specific examples. It should be noted that the examples below are merely intended to assist those skilled in the art in understanding the embodiments of this application, but are not intended to use specific values or specific scenarios in the examples to limit the embodiments of this application. Apparently, those skilled in the art may make various equivalent modifications or variations based on the examples illustrated below, and such modifications or variations also fall within the scope of embodiments of this application.

In GES-TM attribute RAHT inter prediction encoding provided in a related technology, whether to perform predictive encoding on attribute information of a point cloud by using inter prediction or intra prediction may be determined by using a syntax element in an adaptation parameter set (aps) at a higher layer. In addition, a quantity of start layers for inter prediction may be determined by using a syntax element (treeDepth). In other words, at a RAHT layer below the quantity of start layers, only RAHT intra prediction is used. There are two main problems in the attribute encoding scheme. First, in the attribute encoding scheme, distribution of AC coefficients of different RAHT layers in different slices is not analyzed, but an inter encoding scheme of attribute information of a current sequence is directly determined in a sequence set. Second, a quantity of layers for inter prediction is determined in aps because intra correlation of AC coefficients of lower layers in a RAHT-layer structure is stronger than inter correlation. However, such an encoding scheme does not fully and effectively utilize the distribution of AC coefficients of different RAHT layers, resulting in low encoding efficiency of attribute information. Based on the foregoing problems, this example introduces a new encoding scheme. First, three attribute information encoding modes are introduced: RAHT intra prediction+transform encoding, RAHT inter prediction+RAHT intra prediction+transform encoding, and RAHT encoding. Next, before AC coefficients of different RAHT layers are encoded, an optimal encoding mode of a current layer is obtained by using a rate-distortion optimization algorithm at an encoding end. Then, the optimal encoding mode of the current layer is transferred to the decoding end, and the decoding end adaptively recovers the AC coefficients of the current layer by using the optimal encoding mode of the current layer, so as to complete encoding and decoding of the attribute information of the point cloud, and finally improve encoding efficiency of attribute of the point cloud.

In a specific implementation process, first, a RAHT layer is defined in this example. Currently a RAHT sequence of attribute information is to perform partition sequentially from a root node to a voxel level (1×1×1), thereby completing encoding and attribute reconstruction of attribute information of an entire point cloud. Based on this, a layer obtained by performing one downsampling along the Z direction, Y direction, and X direction each time may be defined as one RAHT layer. For details, refer to FIG. 27.

Second, based on the RAHT layer, an encoding mode of a current layer is adaptively selected from the following three encoding modes: RAHT intra prediction+transform encoding; RAHT intra prediction+RAHT intra prediction+transform encoding; and RAHT encoding. An optimal encoding mode of the current layer may be obtained from the three encoding modes by using the rate-distortion optimization algorithm, and the optimal encoding mode is transferred to the decoding end. The decoding end reconstructs and recovers the attribute information of nodes in the current layer by using the parsed optimal decoding mode. When rate distortion optimization is performed, reconstructed attribute information of each encoding mode and a distortion parameter D of original attribute information are first calculated, and then a bit rate parameter R of each encoding mode is obtained. Then, the rate distortion cost of each encoding mode may be calculated based on the following formula:

$$J = D + λ \times R \qquad ( 30 )$$

Herein λ may be obtained by means of calculation by using an attribute quantization parameter, and a calculation manner of t is as follows:

$$λ = {2}^{\frac{QP - 4}{6}} \times N \qquad ( 31 )$$

The parameter N may be set to different values depending on reflectance and color.

After an optimal encoding mode of each layer is obtained, the optimal encoding mode of each layer may be added to an attribute brick header.

A specific algorithm at the encoding end is as follows.

Step 1: Whether nodes of the current layer can adopt attribute prediction is adaptively determined according to a quantity of neighboring nodes of the current layer and a quantity of neighboring nodes of a parent node.

Step 2: If the nodes of the current layer can adopt attribute prediction and attribute inter prediction can be performed, a rate-distortion optimization algorithm is introduced to determine an optimal encoding mode of the current layer. For example, costs corresponding to respective three encoding modes may be obtained by means of calculation by encoding each node at the current layer, so as to obtain the optimal encoding mode.

Step 3: Attribute information of the current layer node is encoded by using the optimal encoding mode.

A specific algorithm at the decoding end is as follows:

Step 1: Whether the nodes of the current layer can adopt attribute prediction is adaptively determined according to a quantity of neighboring nodes of the current layer and a quantity of neighboring nodes of a parent node.

Step 2: If the nodes of the current layer can adopt attribute prediction and attribute inter prediction can be performed, the optimal decode mode of the current layer is parsed from a bitstream.

Step 3: The attribute information of the current layer node is decoded by using the optimal decoding mode.

In this example, during RAHT inter prediction on the attribute information, if the current layer can perform attribute inter prediction, three encoding modes will first be introduced for the current layer, and then a rate-distortion optimization algorithm is used to select an optimal encoding mode for encoding, thereby improving encoding efficiency of point cloud attribute.

Syntax elements in the attribute data unit header (Attribute data unit header syntax) are as follows:

| | Descriptor | Semantics |
|---|---|---|
| attribute_data_unit_header( ) { | | |
| adu_attr_parameter_set_id | u(4) | 7.4.4.2 |
| adu_reserved_zero_3bits | u(3) | 7.4.4.2 |
| adu_sps_attr_idx | ue(v) | 7.4.4.2 |
| adu_slice_id | ue(v) | 7.4.4.2 |
| if( lod_dist_log2_offset_present) | | |
| lod_dist_log2_offset | se(v) | 10.6.2 |
| if(last_comp_pred_enabled && AttrDim == 3) | | |
| for(dpth = O; dpth :S lod_max_levels_minusl; dpth++) | | |
| last_comp_pred_coeff_diffIdpth] | se(v) | 10.6.10.1 |
| if( inter_comp_pred_enabled) | | |
| for(dpth = O; dpth :S lod_max_levels_minusl; dpth++) | | |
| for( = 1; < AttrDim; ++) | | |
| inter_comp_pred_coeff_diff[dpth][ ] | se(v) | 10.6.10.1 |
| if(attr_qp_offsets_present) | | |
| for(qc = O; qc < Min(2, AttrDim ); qc++) | | |
| attr_qp_offset[ qc] | se(v) | 10.7.1 |
| attr_qp_layers_present | u(1) | 10.7.1 |
| if(attr_qp_layers_present) { | | |
| attr_qp_layer_cnt_minus1 | ue(v) | 10.7.1 |
| for(dpth O; dpth < attr_qp_layer_cnt_minusl; | | |
| dpth++) | | |
| for(qc = O; qc < Min(2, AttrDim ); qc++) | | |
| attr_qp_layer_offset[dpth ][ qc] | se(v) | 10.7.1 |
| } | | |
| attr_qp_region_cnt | ue(v) | 10.7.1 |
| if(attr_qp_region_cnt) | | |
| attr_qp_region_bits_minus1 | ue(v) | 10.7.1 |
| for(= O; < attr_qp_region_cnt; ++) { | | |
| if(−,attr_coord_conv_enabled) { | | |
| for(= O; < 3; ++) | | |
| attr_qp_region_origin_xyz[ ][ ] | u(v) | 10.7.1 |
| for(= O; < 3; ++) | | |
| attr_qp_region_size_minusl_xyz[ ][ ] | u(v) | 10.7.1 |
| } else { | | |
| for(= O; < 3; ++) | | |
| attr_qp_region_origin_rpi[ ][ ] | u(v) | 10.7.1 |
| for(= O; < 3; ++) | | |
| attr_qp_region_size_minusl_rpi[ ][ ] | u(v) | 10.7.1 |
| } | | |
| for(ps = O; ps < Min(2, AttrDim); ps++) | | |
| attr_qp_region_offset[ ][ps] | se(v) | 10.7.1 |
| } | | |
| disableAttrInterPred | u(1) | |
| if(attr_coding_type == 0&& !disableAttrInterPred) | | |
| if(raht_prediction_enabled){ | | |
| attr_code_mode_cnt | ue(v) | |
| for( = 0; < attr_code_mode_cnt: ++) | | |
| attr_code_mode[i] | u(1) | |
| } | | |
| byte_alignment( ) | | |
| } | | |

The syntax elements from the third row to the eighth row in the foregoing syntax elements are syntax elements newly introduced in this example on the basis of syntax elements provided in a related technology. It can be seen from the syntax elements that when attribute information of a point cloud uses RAHT inter prediction (attr_coding_type==0 && !disableAttrInterPred), in this example, an optimal encoding mode is selected from a plurality of encoding modes (a quantity of encoding modes is determined based on attr_code_mode_cnt). For other content of the foregoing syntax elements, refer to the related technology. Details are not described herein again.

The method embodiments of this application are described above in detail with reference to FIG. 1 to FIG. 28. Apparatus embodiments of this application are described below in detail with reference to FIG. 29 to FIG. 32. It should be understood that the descriptions of the method embodiments correspond to descriptions of the apparatus embodiments, and therefore, for parts that are not described in detail, reference may be made to the foregoing method embodiments.

FIG. 29 is a schematic structural diagram of a decoder according to an embodiment of this application. As shown in FIG. 29, the decoder 2900 may include a first decoding unit 2910 and a second decoding unit 2920.

The first decoding unit 2910 is configured to parse a bitstream to determine first information, where the first information is used to indicate a target decoding mode from a plurality of decoding modes corresponding to a current layer, and the plurality of decoding modes include RAHT decoding and RAHT prediction combined with transform decoding; and

The second decoding unit 2920 is configured to decode attribute information of a node at the current layer according to the target decoding mode.

In some implementations, the RAHT prediction combined with transform decoding includes at least one of the following: RAHT intra prediction combined with transform decoding; RAHT inter prediction combined with transform decoding; or a combination of RAHT intra prediction combined with transform decoding and RAHT inter prediction combined with transform decoding.

In some implementations, the plurality of decoding modes include: RAHT decoding; RAHT intra prediction combined with transform decoding; and a combination of RAHT intra prediction combined with transform decoding and RAHT inter prediction combined with transform decoding.

In some implementations, the plurality of decoding modes include RAHT decoding, the RAHT intra prediction combined with transform decoding, and the RAHT inter prediction combined with transform decoding.

In some implementations, the first decoding unit 2910 is configured to: determine whether the attribute information meets a condition for performing inter prediction; and in a case that the attribute information meets the condition, parse the bitstream to determine the first information.

In some implementations, the decoder 2900 further includes a third decoding unit, configured to perform RAHT decoding and/or RAHT intra prediction combined with transform decoding on the attribute information in a case that the attribute information does not meet the condition.

In some implementations, the target decoding mode is a combination of RAHT intra prediction combined with transform decoding and RAHT inter prediction combined with transform decoding, and the second decoding unit 2920 is configured to: determine an intra predicted value and an inter predicted value of an AC coefficient of the node at the current layer based on the target decoding mode; fuse the intra predicted value and the inter predicted value to determine a target predicted value of the AC coefficient; and determine reconstructed attribute information of the node at the current layer based on the target predicted value.

In some implementations, the plurality of decoding modes include RAHT inter prediction combined with transform decoding, and a reference frame of the RAHT inter prediction combined with transform decoding is determined from a first reference frame and a second reference frame, the first reference frame is a reference frame that has undergone motion compensation, and the second reference frame is a reference frame that has not undergone motion compensation.

In some implementations, the motion compensation is local motion compensation or global motion compensation.

In some implementations, the decoder 2900 further includes a fourth decoding unit, configured to: in a case that the target decoding mode is the RAHT inter prediction combined with transform decoding, parse the bitstream to determine second information, where the second information is used to indicate a reference frame corresponding to the RAHT inter prediction combined with transform decoding.

In some implementations, the decoder 2900 further includes: a fourth decoding unit, configured to parse the bitstream to determine third information, where the third information is used to indicate whether the reference frame that has undergone motion compensation is used for RAHT inter prediction.

In some implementations, the third information corresponds to a slice or a RAHT layer.

In some implementations, the second decoding unit 2920 is configured to: parse the bitstream to determine a quantized coefficient of the node at the current layer; perform inverse quantization on the quantized coefficient to determine an AC coefficient of the node at the current layer; and perform inverse transform on the AC coefficient based on the target decoding mode, to determine reconstructed attribute information of the node at the current layer.

In some implementations, the current layer is determined based on partition performed on a previous layer of the current layer at least once in each of an X direction, a Y direction, and a Z direction.

In some implementations, the first information is included in an attribute brick header.

In some implementations, the RAHT prediction combined with transform decoding includes the RAHT inter prediction combined with transform decoding, and a reference frame of the RAHT inter prediction combined with transform decoding is a reference frame that has undergone global motion compensation or local motion compensation.

In some implementations, the decoding method is applied to GES-TM.

It may be understood that in embodiments of this application, the term “unit” may be a partial circuit, a partial processor, a partial program or software, or the like. Certainly, the term “unit” may be a module or may be in a non-modular form. In addition, components in embodiments may be integrated into one processing unit, or each of the units may exist alone physically, or two or more units may be integrated into one unit. The foregoing integrated unit may be implemented in a form of hardware, or may be implemented in a form of a software functional module.

When the integrated unit is implemented in a form of a software functional module and not sold or used as an independent product, the integrated unit may be stored in a computer-readable storage medium. Based on such an understanding, the technical solutions of embodiments essentially, or the part contributing to the conventional technology, or all or some of the technical solutions may be implemented in a form of a software product. The computer software product is stored in a storage medium and includes several instructions for instructing a computer device (which may be a personal computer, a server, or a network device) or a processor to execute all or some of the steps of the methods described in the embodiments. The foregoing storage medium includes various media that may store a program code, such as a USB flash drive, a portable hard drive, a read-only memory (ROM), a random access memory (RAM), a magnetic disk, or an optical disc.

Therefore, an embodiment of this application provides a computer-readable storage medium, applied to a decoder 2900. The computer-readable storage medium stores a computer program, and the computer program, when executed by a processor, causes the decoding method according to any one of the foregoing embodiments to be implemented.

Based on the composition of the decoder 2900 and the computer-readable storage medium, referring to FIG. 30, FIG. 30 is a schematic diagram of a structure of specific hardware of the decoder 2900 according to an embodiment of this application. As shown in FIG. 30, the decoder 3000 may include a communications interface 3010, a memory 3020, and a processor 3030. The components are coupled together through a bus system 3040. It may be understood that the bus system 3040 is configured to implement connection and communication between these components. The bus system 3040 may further include a power bus, a control bus, a status signal bus, and the like in addition to a data bus. However, for clarity of description, various buses are marked as the bus system 3040 in FIG. 29.

The communications interface 3010 is configured to receive and transmit signals in a process of transmitting and receiving information with other external network elements.

The memory 3020 is configured to store a computer program.

The processor 3030 is configured to run the computer program to execute the following operations:
parsing a bitstream to determine first information, where the first information is used to indicate a target decoding mode from a plurality of decoding modes corresponding to a current layer, and the plurality of decoding modes include RAHT decoding and RAHT prediction combined with transform decoding; and
decoding attribute information of a node at the current layer according to the target decoding mode.

It may be understood that the memory 3020 in the embodiments of this application may be a volatile memory or a non-volatile memory, or may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. By way of example rather than limitative description, many forms of RAMs are available, for example, a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct Rambus random access memory (DRRAM). The memory 3020 in the systems and the methods described in this application includes but is not limited to these memories and any memory of another appropriate type.

However, the processor 3030 may be an integrated circuit chip having a signal processing capability. In an implementation process, each step of the foregoing method may be completed by using an integrated logic circuit of hardware in the processor 3030 or an instruction in a form of software. The processor 3030 may be a general-purpose processor, a digital signal processor (DSP), an application-specific integrated circuit (ASIC), a field-programmable gate array (FPGA) or another programmable logic device, a discrete gate or a transistor logic device, or a discrete hardware component. The processor can implement or execute the methods, steps and logical block diagrams disclosed in embodiments of this application. The general-purpose processor may be a microprocessor, or the processor may be any conventional processor or the like. The steps of the methods disclosed with reference to embodiments of this application may be directly executed by a hardware decoding processor, or executed by a combination of hardware and software modules in the decoding processor. The software module may be located in a mature storage medium in the art, for example, a random access memory, a flash memory, a read-only memory, a programmable read-only memory, an electrically erasable programmable memory, or a register. The storage medium is located in the memory 3020, and the processor 3030 reads information in the memory 3020 and completes the steps of the foregoing methods in combination with hardware of the processor.

It may be understood that these embodiments described in this application may be implemented by hardware, software, firmware, middleware, microcode, or a combination thereof. For hardware implementation, the processing unit may be implemented in one or more application-specific integrated circuits (ASIC), digital signal processors (DSP), digital signal processing devices (DSPD), programmable logic devices (PLD), field-programmable gate arrays (FPGA), general-purpose processors, controllers, microcontrollers, microprocessors, and other electronic units configured to execute the functions described in this application, or a combination thereof. For software implementation, the technologies described in this application can be implemented by modules (such as processes and functions) that execute the functions described in this application. Software code may be stored in a memory and executed by a processor. The memory can be implemented in the processor or outside the processor.

Optionally, in another embodiment, the processor 3030 is further configured to execute the decoding method in any one of the foregoing embodiments when running the computer program.

FIG. 31 is a schematic structural diagram of an encoder according to an embodiment of this application. As shown in FIG. 31, the encoder 3100 includes a first determining unit 3110 and a first encoding unit 3120.

The first determining unit 3110 is configured to determine a target encoding mode corresponding to a current layer from a plurality of encoding modes, where the plurality of encoding modes include RAHT encoding and RAHT prediction combined with transform encoding.

The first encoding unit 3120 is configured to encode attribute information of a node at the current layer according to the target encoding mode.

In some implementations, the RAHT prediction combined with transform encoding includes at least one of the following: RAHT intra prediction combined with transform encoding; RAHT inter prediction combined with transform encoding; or a combination of RAHT intra prediction combined with transform encoding and RAHT inter prediction combined with transform encoding.

In some implementations, the plurality of encoding modes include RAHT encoding, the RAHT intra prediction combined with transform encoding, and the combination of the RAHT intra prediction combined with transform encoding and the RAHT inter prediction combined with transform encoding.

In some implementations, the plurality of encoding modes include RAHT encoding; RAHT intra prediction combined with transform encoding; and RAHT inter prediction combined with transform encoding.

In some implementations, the encoder 3100 further includes a second encoding unit, configured to write first information into a bitstream, where the first information is used to indicate the target encoding mode.

In some implementations, the first information is included in an attribute brick header.

In some implementations, the first determining unit 3110 is configured to: determine whether the attribute information meets a condition for performing inter prediction; and if the attribute information meets the condition, determine the target encoding mode from the plurality of encoding modes.

In some implementations, the encoder 3100 further includes a third encoding unit, configured to: in a case that the attribute information does not meet the condition, perform RAHT encoding and/or RAHT intra prediction combined with transform encoding on the attribute information.

In some implementations, the target encoding mode is a combination of RAHT intra prediction combined with transform encoding and RAHT inter prediction combined with transform encoding, and the first encoding unit 3120 is configured to: determine an intra predicted value and an inter predicted value of an AC coefficient of the node at the current layer based on the target encoding mode; fuse the intra predicted value and the inter predicted value to determine a target predicted value of the AC coefficient; and determine reconstructed attribute information of the node at the current layer based on the target predicted value.

In some implementations, the plurality of encoding modes include RAHT inter prediction combined with transform encoding and a reference frame of the RAHT inter prediction combined with transform encoding is determined from a first reference frame and a second reference frame, the first reference frame is a reference frame that has undergone motion compensation, and the second reference frame is a reference frame that has not undergone motion compensation.

In some implementations, the motion compensation is local motion compensation or global motion compensation.

In some implementations, the reference frame of the RAHT inter prediction combined with transform encoding is determined based on a rate distortion cost corresponding to the first reference frame and a rate distortion cost corresponding to the second reference frame.

In some implementations, the encoder 3100 further includes a fourth encoding unit, configured to: in a case that the target encoding mode is the RAHT inter prediction combined with transform encoding, write second information into a bitstream, where the second information is used to indicate the reference frame corresponding to the RAHT inter prediction combined with transform encoding.

In some implementations, the encoder 3100 further includes a fifth encoding unit, configured to write third information into a bitstream, where the third information is used to indicate whether the reference frame that has undergone motion compensation is used for RAHT inter prediction.

In some implementations, the third information corresponds to a slice or a RAHT layer.

In some implementations, the target encoding mode is determined based on rate distortion costs of the plurality of encoding modes.

In some implementations, the target encoding mode is an encoding mode with the smallest rate distortion cost in the plurality of decoding modes.

In some implementations, a rate distortion cost of the target encoding mode is determined based on a distortion parameter, a bit rate parameter, and a Lagrange multiplier that correspond to the target encoding mode, and the Lagrange multiplier is determined based on a quantization parameter of the attribute information.

In some implementations, the first encoding unit 3120 is configured to determine a quantized coefficient according to an AC coefficient determined based on the target encoding mode; and determine, according to the quantized coefficient, an encoded bit corresponding to the attribute information.

In some implementations, the current layer is determined based on partition performed on a previous layer of the current layer at least once in each of an X direction, a Y direction, and a Z direction.

In some implementations, the RAHT prediction combined with transform encoding includes the RAHT inter prediction combined with transform encoding, and a reference frame of the RAHT inter prediction combined with transform encoding is a reference frame that has undergone global motion compensation or local motion compensation.

In some implementations, the encoding method is applied to GES-TM.

It may be understood that in embodiments of this application, the term “unit” may be a partial circuit, a partial processor, a partial program or software, or the like. Certainly, the term “unit” may be a module or may be in a non-modular form. In addition, components in embodiments may be integrated into one processing unit, or each of the units may exist alone physically, or two or more units may be integrated into one unit. The foregoing integrated unit may be implemented in a form of hardware, or may be implemented in a form of a software functional module.

When the integrated unit is implemented in a form of a software functional module and not sold or used as an independent product, the integrated unit may be stored in a computer-readable storage medium. Based on such an understanding, the technical solutions of embodiments essentially, or the part contributing to the conventional technology, or all or some of the technical solutions may be implemented in a form of a software product. The computer software product is stored in a storage medium and includes several instructions for instructing a computer device (which may be a personal computer, a server, or a network device) or a processor to execute all or some of the steps of the methods described in the embodiments. The foregoing storage medium includes: any medium that can store program code, such as a USB flash drive, a removable hard disk, a ROM, a RAM, a magnetic disk, or an optical disc.

Therefore, an embodiment of this application provides a computer-readable storage medium, applied to an encoder 3100. The computer-readable storage medium stores a computer program, and the computer program, when executed by a processor, causes the decoding method according to any one of the foregoing embodiments to be implemented.

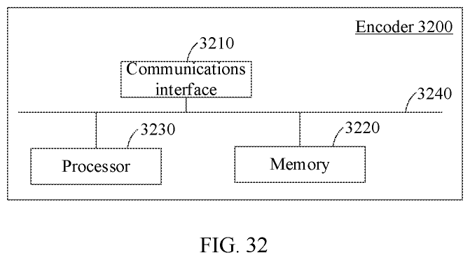

Based on the composition of the encoder 3100 and the computer-readable storage medium, referring to FIG. 32, FIG. 32 is a schematic diagram of a structure of specific hardware of the encoder 3100 according to an embodiment of this application. As shown in FIG. 32, the encoder 3200 may include a communications interface 3210, a memory 3220, and a processor 3230. The components are coupled together through a bus system 3240. It may be understood that the bus system 3240 is configured to implement connection and communication between these components. The bus system 3240 may further include a power bus, a control bus, a status signal bus, and the like in addition to a data bus. However, for clarity of description, various buses are marked as the bus system 3240 in FIG. 32.

The communications interface 3210 is configured to receive and transmit signals in a process of transmitting and receiving information with other external network elements.

The memory 3220 is configured to store a computer program.

The processor 3230 is configured to run the computer program to execute the following operations:
determining a target encoding mode corresponding to a current layer from a plurality of encoding modes, where the plurality of encoding modes include RAHT encoding and RAHT prediction combined with transform encoding; and
encoding attribute information of a node at the current layer according to the target encoding mode.

It may be understood that the memory 3220 in the embodiments of this application may be a volatile memory or a non-volatile memory, or may include a volatile memory and a non-volatile memory. The non-volatile memory may be a ROM, a PROM, an EPROM, an EEPROM, or a flash memory. The volatile memory may be a RAM that serves as an external cache. By way of example but not limitation, many forms of RAM are available, such as SRAM, DRAM, SDRAM, DDRSDRAM, ESDRAM, SLDRAM, and DRRAM. The memory 3220 in the systems and the methods described in this application includes but is not limited to these memories and any memory of another appropriate type.

However, the processor 3230 may be an integrated circuit chip having a signal processing capability. In an implementation process, each step of the foregoing method may be completed by using an integrated logic circuit of hardware in the processor 3230 or an instruction in a form of software. The foregoing processor 3230 may be a general-purpose processor, a DSP, an ASIC, an FPGA, or another programmable logic component, a discrete gate or a transistor logic component, or a discrete hardware component. The processor can implement or execute the methods, steps and logical block diagrams disclosed in embodiments of this application. The general-purpose processor may be a microprocessor, or the processor may be any conventional processor or the like. The steps of the methods disclosed with reference to embodiments of this application may be directly executed by a hardware decoding processor, or executed by a combination of hardware and software modules in the decoding processor. The software module may be located in a mature storage medium in the art, for example, a random access memory, a flash memory, a read-only memory, a programmable read-only memory, an electrically erasable programmable memory, or a register. The storage medium is located in the memory 3220, and the processor 3230 reads information in the memory 3220 and completes the steps of the foregoing methods in combination with hardware of the processor.

It may be understood that these embodiments described in this application may be implemented by hardware, software, firmware, middleware, microcode, or a combination thereof. For hardware implementation, the processing unit may be implemented in one or more ASICs, DSPs, DSPD, PLD, FPGAs, general purpose processors, controllers, microcontrollers, microprocessors, other electronic units configured to perform the functions described in this application, or combinations thereof. For software implementation, the technologies described in this application can be implemented by modules (such as processes and functions) that execute the functions described in this application. Software code may be stored in a memory and executed by a processor. The memory can be implemented in the processor or outside the processor.

Optionally, in another embodiment, the processor 3230 is further configured to execute the encoding method in any one of the foregoing embodiments when running the computer program.

An embodiment of this application further provides a computer-readable storage medium. The computer-readable storage medium is a non-volatile computer-readable storage medium for storing a bitstream. The bitstream may be generated by using an encoding method of an encoder, or the bitstream is decoded by using a decoding method of a decoder. The decoding method may be the decoding method in any one of the foregoing embodiments, and the encoding method may be the encoding method in any one of the foregoing embodiments.

It should be noted that, in this application, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. In the absence of further restrictions, the element limited by the sentence “including a . . . ” does not exclude the existence of other identical elements in the process, method, item or device including this element.

The foregoing sequence numbers of embodiments of this application are merely described, and do not represent advantages or disadvantages of the embodiments.

The disclosed methods provided in the several method embodiments of this application may be randomly combined with each other in the case of no conflicts, to obtain new method embodiments.

The disclosed features provided in the several product embodiments of this application may be randomly combined with each other in the case of no conflicts, to obtain new product embodiments.

The disclosed features provided in the several method or device embodiments of this application may be randomly combined with each other in the case of no conflicts, to obtain new method embodiments or device embodiments.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A decoding method, applied to a decoder and comprising:
parsing a bitstream to determine first information, wherein the first information is used to indicate a target decoding mode from a plurality of decoding modes corresponding to a current layer, and the plurality of decoding modes comprise region adaptive hierarchical transform (RAHT) decoding and RAHT prediction combined with transform decoding; and
decoding attribute information of a node at the current layer according to the target decoding mode.

2. The method according to claim 1, wherein the RAHT prediction combined with transform decoding comprises at least one of following:
RAHT intra prediction combined with transform decoding;
RAHT inter prediction combined with transform decoding; or
a combination of RAHT intra prediction combined with transform decoding and RAHT inter prediction combined with transform decoding.

3. The method according to claim 1, wherein the parsing the bitstream to determine the first information comprises:
determining whether the attribute information meets a condition for performing inter prediction; and
in a case that the attribute information meets the condition, parsing the bitstream to determine the first information.

4. The method according to claim 3, wherein the method further comprises:
in a case that the attribute information does not meet the condition, performing RAHT decoding and/or RAHT intra prediction combined with transform decoding on the attribute information.

5. The method according to claim 1, wherein before the decoding the attribute information of the node at the current layer according to the target decoding mode, the method further comprises:
parsing the bitstream to determine a quantized coefficient of the node at the current layer; and
performing inverse quantization on the quantized coefficient to determine an AC coefficient of the node at the current layer,
wherein the decoding the attribute information of the node at the current layer according to the target decoding mode comprises:
performing prediction and/or inverse transform on the AC coefficient based on the target decoding mode, to determine reconstructed attribute information of the node at the current layer.

6. The method according to claim 1, wherein the current layer is determined based on partition performed on a previous layer of the current layer at least once in each of an X direction, a Y direction, and a Z direction.

7. The method according to claim 1, wherein the first information is comprised in an attribute brick header.

8. An encoding method, applied to an encoder, comprising:
determining a target encoding mode corresponding to a current layer from a plurality of encoding modes, wherein the plurality of encoding modes comprise region adaptive hierarchical transform RAHT encoding and RAHT prediction combined with transform encoding; and
encoding attribute information of a node at the current layer according to the target encoding mode.

9. The method according to claim 8, wherein the RAHT prediction combined with transform encoding comprises at least one of following:
RAHT intra prediction combined with transform encoding;
RAHT inter prediction combined with transform encoding; or
RAHT intra prediction combined with transform encoding and RAHT inter prediction combined with transform encoding.

10. The method according to claim 8, wherein the method further comprises:
writing first information into a bitstream, wherein the first information is used to indicate the target encoding mode.

11. The method according to claim 10, wherein the first information is comprised in an attribute brick header.

12. The method according to claim 8, wherein the determining the target encoding mode corresponding to the current layer from the plurality of encoding modes comprises:
determining whether the attribute information meets a condition for performing inter prediction; and
if the attribute information meets the condition, determining the target encoding mode from the plurality of encoding modes.

13. The method according to claim 12, wherein the method further comprises:
in a case that the attribute information does not meet the condition, performing RAHT encoding and/or RAHT intra prediction combined with transform encoding on the attribute information.

14. The method according to claim 8, wherein the method further comprises:
writing third information into a bitstream, wherein the third information is used to indicate whether the reference frame that has undergone motion compensation is used for RAHT inter prediction,
wherein the third information corresponds to a slice or a RAHT layer.

15. The method according to claim 8, wherein the target encoding mode is determined based on rate distortion costs of the plurality of encoding modes.

16. The method according to claim 15, wherein a rate distortion cost of the target encoding mode is determined based on a distortion parameter, a bit rate parameter, and a Lagrange multiplier that correspond to the target encoding mode, and the Lagrange multiplier is determined based on a quantization parameter of the attribute information.

17. The method according to claim 8, wherein the encoding the attribute information of the node at the current layer according to the target encoding mode comprises:
determining a quantized coefficient according to an AC coefficient determined based on the target encoding mode; and
determining, according to the quantized coefficient, an encoded bit corresponding to the attribute information.

18. The method according to claim 8, wherein the current layer is determined based on partition performed on a previous layer of the current layer at least once in each of an X direction, a Y direction, and a Z direction.

19. The method according to claim 8, wherein the RAHT prediction combined with transform encoding comprises RAHT inter prediction combined with transform encoding, and a reference frame of the RAHT inter prediction combined with transform encoding is a reference frame that has undergone global motion compensation or local motion compensation.

20. A non-volatile computer-readable storage medium, having a computer program and a bitstream stored thereon, wherein the computer program, when executed by a processor, enables the processor to perform the steps of the encoding method of claim 8 to generate the bitstream.
